(19) United States
(12) Patent Application Publication
(10) Pub. No.: US 2026/0227598 A1
(43) Pub. Date: Aug. 6, 2026

(54) IMAGING OPTICAL SYSTEM AND IMAGING APPARATUS

(71) Applicant: NIDEC INSTRUMENTS CORPORATION, Nagano (JP)

(72) Inventor: Tadashi KOMIYAMA, Nagano (JP)

(73) Assignee: NIDEC INSTRUMENTS CORPORATION, Nagano (JP)

(21) Appl. No.: 19/430,258

(22) Filed: Dec. 23, 2025

(30) Foreign Application Priority Data
Dec. 27, 2024 (JP) 2024-231885

(51) Int. Cl. G02B 9/64

(52) U.S. Cl. CPC G02B 9/64

(57) ABSTRACT

An imaging optical system includes: a front group, a diaphragm, and a rear group in order from an object side to an image side. The front group includes: a first group having negative power, and a second group having positive power in order from the object side to the image side. The second group includes: a third lens, and a fourth lens that is adjacent to the third lens on the image side and is disposed closest to the image side. Where ν21 is an Abbe number of the third lens, ν22 is an Abbe number of the fourth lens, f3 is a focal length of the third lens, and f4 is a focal length of the fourth lens, the following conditional expressions are satisfied:

$$v 21 < 30 \text{.000}$$

$$44. < v 22 , and$$

$$0. < \vert f 3 / f 4 \vert < 0. 500 .$$

### CROSS REFERENCE TO RELATED APPLICATION

The present invention claims priority under 35 U.S.C. § 119 to Japanese Application No. 2024-231885 filed Dec. 27, 2024, and the entire content of which is incorporated herein by reference.

### TECHNICAL FIELD

At least an embodiment of the present invention relates to an imaging optical system and an imaging apparatus.

### BACKGROUND

An imaging optical system used for an in-vehicle camera or a surveillance camera is described in Japanese Unexamined Patent Application Publication No. 2011-107425. The imaging optical system of Japanese Unexamined Patent Application Publication No. 2011-107425 is composed of an aperture diaphragm, a first lens group disposed on an object side of the aperture diaphragm, and a second lens group disposed on an image side of the aperture diaphragm. The first lens group includes, in order from the object side, a first lens, a second lens, a third lens, and a fourth lens. The second lens group includes, in order from the object side, a fifth lens, a sixth lens, and a seventh lens. The sixth lens and the seventh lens constitute a cemented lens. The cemented lens is disposed closest to the image side and corrects chromatic aberration.

In order to obtain a clear image in an imaging optical system used for an in-vehicle camera or a surveillance camera, it is required to further satisfactorily correct chromatic aberration.

In view of the above-described problems, at least an embodiment of the present invention provides an imaging optical system capable of satisfactorily correcting chromatic aberration, and an imaging apparatus including the imaging optical system.

### SUMMARY

In order to solve the above problem, one aspect of an imaging optical system of at least an embodiment of the present invention includes: a front group, a diaphragm, and a rear group in order from an object side to an image side. The front group includes: a first group having negative power, and a second group having positive power in order from the object side to the image side. The second group includes: a second group first lens, and a second group second lens that is adjacent to the second group first lens on the image side and is disposed closest to the image side. Where ν21 is an Abbe number of the second group first lens, ν22 is an Abbe number of the second group second lens, f3 is a focal length of the second group first lens, and f4 is a focal length of the second group second lens, the following conditional expressions are satisfied:

$$v 21 < 30.$$

$$40. < v 22$$

$$0. < \vert f 3 / f 4 \vert < 0.5 .$$

One aspect of an imaging apparatus of at least an embodiment of the present invention includes: the imaging optical system; and an imaging element disposed on an image side of the imaging optical system.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an explanatory diagram of an imaging apparatus according to Embodiment 1;

FIG. 2 is a diagram showing data of the imaging optical system of Embodiment 1;

FIG. 3 is a diagram showing spherical aberration of the imaging optical system shown in FIG. 1;

FIG. 4 is a diagram showing chromatic aberration of magnification of the imaging optical system shown in FIG. 1;

FIG. 5 is a diagram showing astigmatism and distortion of the imaging optical system shown in FIG. 1;

FIG. 6 is a diagram showing lateral aberration of the imaging optical system shown in FIG. 1;

FIG. 7 is an explanatory diagram of an imaging apparatus according to Embodiment 2;

FIG. 8 is a diagram showing data of the imaging optical system of Embodiment 2;

FIG. 9 is a diagram showing spherical aberration of the imaging optical system shown in FIG. 7;

FIG. 10 is a diagram showing chromatic aberration of magnification of the imaging optical system shown in FIG. 7;

FIG. 11 is a diagram showing astigmatism and distortion of the imaging optical system shown in FIG. 7;

FIG. 12 is a diagram showing lateral aberration of the imaging optical system shown in FIG. 7;

FIG. 13 is an explanatory diagram of an imaging apparatus according to Embodiment 3;

FIG. 14 is a diagram showing data of the imaging optical system of Embodiment 3;

FIG. 15 is a diagram showing spherical aberration of the imaging optical system shown in FIG. 13;

FIG. 16 is a diagram showing chromatic aberration of magnification of the imaging optical system shown in FIG. 13;

FIG. 17 is a diagram showing astigmatism and distortion of the imaging optical system shown in FIG. 13;

FIG. 18 is a diagram showing lateral aberration of the imaging optical system shown in FIG. 13;

FIG. 19 is an explanatory diagram of an imaging apparatus according to Embodiment 4;

FIG. 20 is a diagram showing data of the imaging optical system of Embodiment 4;

FIG. 21 is a diagram showing spherical aberration of the imaging optical system shown in FIG. 19;

FIG. 22 is a diagram showing chromatic aberration of magnification of the imaging optical system shown in FIG. 19;

FIG. 23 is a diagram showing astigmatism and distortion of the imaging optical system shown in FIG. 19;

FIG. 24 is a diagram showing lateral aberration of the imaging optical system shown in FIG. 19;

FIG. 25 is an explanatory diagram of an imaging apparatus according to Embodiment 5;

FIG. 26 is a diagram showing data of the imaging optical system of Embodiment 5;

FIG. 27 is a diagram showing spherical aberration of the imaging optical system shown in FIG. 25;

FIG. 28 is a diagram showing chromatic aberration of magnification of the imaging optical system shown in FIG. 25;

FIG. 29 is a diagram showing astigmatism and distortion of the imaging optical system shown in FIG. 25;

FIG. 30 is a diagram showing lateral aberration of the imaging optical system shown in FIG. 25;

FIG. 31 is an explanatory diagram of an imaging apparatus according to Embodiment 6;

FIG. 32 is a diagram showing data of the imaging optical system of Embodiment 6;

FIG. 33 is a diagram showing spherical aberration of the imaging optical system shown in FIG. 31;

FIG. 34 is a diagram showing chromatic aberration of magnification of the imaging optical system shown in FIG. 31;

FIG. 35 is a diagram showing astigmatism and distortion of the imaging optical system shown in FIG. 31;

FIG. 36 is a diagram showing lateral aberration of the imaging optical system shown in FIG. 31;

FIG. 37 is an explanatory diagram of an imaging apparatus according to Embodiment 7;

FIG. 38 is a diagram showing data of the imaging optical system of Embodiment 7;

FIG. 39 is a diagram showing spherical aberration of the imaging optical system shown in FIG. 37;

FIG. 40 is a diagram showing chromatic aberration of magnification of the imaging optical system shown in FIG. 37;

FIG. 41 is a diagram showing astigmatism and distortion of the imaging optical system shown in FIG. 37; and

FIG. 42 is a diagram showing lateral aberration of the imaging optical system shown in FIG. 37.

### DETAILED DESCRIPTION

Hereinafter, Embodiments of an imaging apparatus 200 including an imaging optical system 100 to which at least an embodiment of the present invention is applied will be described. The imaging apparatus 200 is used for an in-vehicle camera or a surveillance camera. In particular, the imaging optical system 100 is suitable for use in a surveillance camera for monitoring the inside of a vehicle.

### Embodiment 1

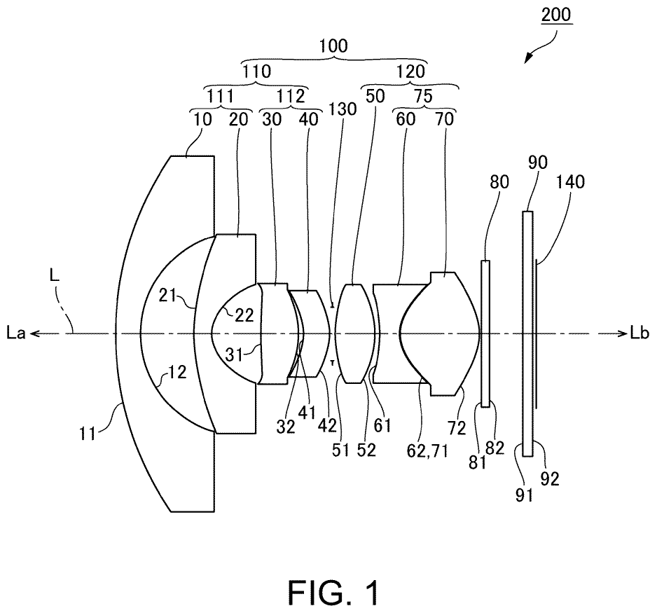

FIG. 1 is an explanatory diagram of an imaging apparatus 200 according to Embodiment 1. As shown in FIG. 1, the imaging apparatus 200 of the present embodiment includes an imaging optical system 100 and an imaging element 140. The imaging optical system 100 includes, in order from an object side La to an image side Lb, a front group 110, a diaphragm 130, a rear group 120, and an infrared cut filter 80. On the image side Lb of the infrared cut filter 80, a translucent cover 90 and the imaging element 140 are disposed in order from the object side La to the image side Lb. The imaging element 140 is disposed on an imaging plane on the image side Lb of the imaging optical system 100.

The front group 110 includes, in order from the object side La to the image side Lb, a first group 111 having negative power and a second group 112 having positive power. The first group 111 consists of, in order from the object side La to the image side Lb, a first lens 10 and a second lens 20. The first lens 10 is made of glass. The first lens 10 has negative power. The first lens 10 has a convex shape on a lens surface 11 on the object side La and has a concave shape on a lens surface 12 on the image side Lb. The second lens 20 is made of resin. The second lens 20 has negative power. The second lens 20 has a convex shape on a lens surface 21 on the object side La and has a concave shape on a lens surface 22 on the image side Lb. The second lens 20 has an aspherical shape on both surfaces.

The second group 112 consists of, in order from the object side La to the image side Lb, a third lens 30 (second group first lens) and a fourth lens 40 (second group second lens). The third lens 30 is made of resin. The third lens 30 has positive power. The third lens 30 has a convex shape in the vicinity of an optical axis L and a concave shape in the periphery of a lens surface 31 on the object side La, and has a convex shape on a lens surface 32 on the image side Lb. The third lens 30 has an aspherical shape on both surfaces. The fourth lens 40 is made of resin. The fourth lens 40 has negative power. The fourth lens 40 has a concave shape on a lens surface 41 on the object side La and has a convex shape on a lens surface 42 on the image side Lb. The fourth lens 40 has an aspherical shape on both surfaces.

The rear group 120 consists of, in order from the object side La to the image side Lb, a fifth lens 50 and a cemented lens 75. The cemented lens 75 consists of, in order from the object side La to the image side Lb, a sixth lens 60 (object-side lens) and a seventh lens 70 (image-side lens). The sixth lens 60 and the seventh lens 70 are cemented by an adhesive.

The fifth lens 50 is made of glass. The fifth lens 50 has positive power. The fifth lens 50 has a convex shape on a lens surface 51 on the object side La and has a convex shape on a lens surface 52 on the image side Lb. The sixth lens 60 is made of resin. The sixth lens 60 has negative power. The sixth lens 60 has a concave shape on a lens surface 61 on the object side La and has a concave shape on a lens surface 62 on the image side Lb. The sixth lens 60 has an aspherical shape on both surfaces. The seventh lens 70 is made of resin. The seventh lens 70 has positive power. The seventh lens 70 has a convex shape on a lens surface 71 on the object side La and has a convex shape on a lens surface 72 on the image side Lb. The seventh lens 70 has an aspherical shape on both surfaces.

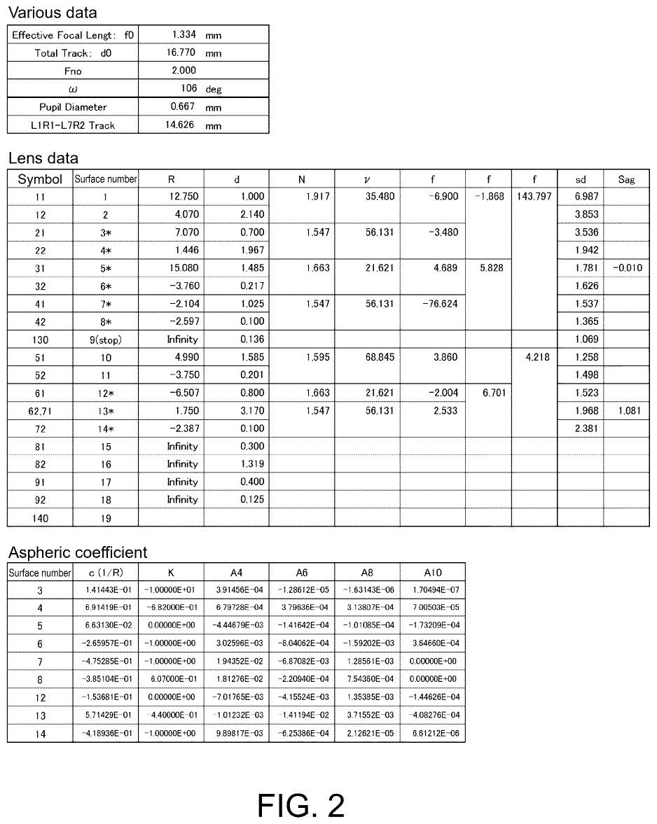

FIG. 2 is a diagram showing data of the imaging optical system 100 of Embodiment 1. Note that the values shown in FIG. 2 have been rounded off.

FIG. 2 shows the following various data. Here, in the various data, the total length of the entire lens system is a distance on the optical axis L from the lens surface 11 on the object side La of the first lens 10 to the imaging surface of the imaging element 140. The total length between the first lens and the seventh lens is a distance on the optical axis L from the lens surface 11 on the object side La of the first lens 10 to the lens surface 72 on the image side Lb of the seventh lens.

Focal length of entire lens system (Effective Focal Length: f0)
Total length of entire lens system (Total Track: d0)
F number of entire lens system (Fno)
Maximum half angle of view (ω)
Pupil diameter (Pupil Diameter)
Total length between first lens and seventh lens (L1R1-L7R2 Track)

Further, FIG. 2 shows lens data of the following lenses. In the lens data, a surface denoted by a surface number with * is an aspheric surface. R is a curvature radius. d is a surface distance. N is a refractive index. ν is an Abbe number. f is a focal length. sd is an effective radius. Sag is a sag amount. The unit of the curvature radius, the surface distance, the focal length, the effective radius, and the sag amount is mm. In addition, FIG. 2 shows an aspheric coefficient indicating a shape of an aspheric surface for each surface number.

Where ν21 is the Abbe number of the third lens 30 (second group first lens), ν22 is the Abbe number of the fourth lens 40 (second group second lens), f3 is the focal length of the third lens 30 (second group first lens), and f4 is the focal length of the fourth lens 40 (second group second lens), the imaging optical system 100 satisfies the following conditional expressions:

$$v 21 < 30. \qquad ( 1 )$$

$$44. < v 22 \qquad ( 2 )$$

$$0. < \vert f 3 / f 4 \vert < 0.5 . \qquad ( 3 )$$

More preferably, the conditional expression (1) satisfies the following conditional expression:

$$21. < v 21 < 30. . \qquad ( 1 A )$$

More preferably, the conditional expression (2) satisfies the following conditional expression:

$$50. < v 22. \qquad ( 2 A )$$

In the present embodiment,

$$v 21 = 21.621$$

$$v 22 = 56.131$$

$$f 3 = 4.689 , and$$

$$f 4 = - 76.624 .$$

Therefore, ν21=21.621 and the conditional expressions (1) and (1A) are satisfied. ν22=56.131 and the conditional expressions (2) and (2A) are satisfied. |f3/f4|=0.061 and the conditional expression (3) is satisfied.

Where ν21 is the Abbe number of the third lens 30 (second group first lens), ν22 is the Abbe number of the fourth lens 40 (second group second lens), Sag71 is the sag amount of the lens surface 71 on the object side of the seventh lens 70 (image-side lens), and sd71 is the effective radius of the lens surface 71 on the object side of the seventh lens 70 (image-side lens), the imaging optical system 100 satisfies the following conditional expressions:

$$v 21 < 30. \qquad ( 1 )$$

$$44. < v 22 , and \qquad ( 2 )$$

$$0.2 < \vert Sag 71 / sd 71 \vert < 0.75 . \qquad ( 4 )$$

More preferably, the conditional expression (1) satisfies the following conditional expression:

$$21. < v 21 < 30. . \qquad ( 1 A )$$

More preferably, the conditional expression (2) satisfies the following conditional expression:

$$50. < v 22. \qquad ( 2 A )$$

More preferably, the conditional expression (4) satisfies the following conditional expression:

$$0.3 < \vert Sag 71 / sd 71 \vert < 0.6 . \qquad ( 4 A )$$

In the present embodiment,

$$v 21 = 21.621$$

$$v 22 = 56.131$$

$$Sag 71 = 1.081 , and$$

$$sd 71 = 1.968 .$$

Therefore, ν21=21.621 and the conditional expressions (1) and (1A) are satisfied. ν22=56.131 and the conditional expressions (2) and (2A) are satisfied. |Sag 71/sd71|=0.550 and the conditional expressions (4) and (4A) are satisfied.

Where Sag31 is the sag amount of the lens surface 31 on the object side of the third lens 30 (second group first lens) and sd31 is the effective radius of the lens surface 31 on the object side of the third lens 30 (second group first lens), the imaging optical system 100 satisfies the following conditional expression:

$$0. < \vert Sag 31 / sd 31 \vert < 0.25 . \qquad ( 5 )$$

In the present embodiment,

$$Sag 31 = - 0.01 , and$$

$$sd 31 = 1.781 .$$

Therefore, |Sag 31/sd31|=0.005 and the conditional expression (5) is satisfied.

Where f0 is the focal length of the entire lens system and f34 is the focal length of the second group 112, the imaging optical system 100 satisfies the following conditional expression:

$$2. < f 34 / f 0 < 6. . \qquad ( 6 )$$

In the present embodiment,

$$f 0 = 1.334 , and$$

$$f 34 = 5.828 .$$

Therefore, f34/f0=4.369 and the conditional expression (6) is satisfied.

Where f0 is the focal length of the entire lens system, R61 is the curvature radius of the lens surface 61 on the object side of the sixth lens 60 (object-side lens) and R71 is the curvature radius of the lens surface 71 on the object side of the seventh lens 70 (image-side lens), the imaging optical system 100 satisfies the following conditional expressions:

$$- 10. < R 61 / f 0 < - 2. , and \qquad ( 7 )$$

$$1. < R 71 / f 0 < 2. . \qquad ( 8 )$$

In the present embodiment,

$$f 0 = 1.334$$

$$R 61 = - 6.507 , and$$

$$R 71 = 1.75 .$$

Therefore, R61/f0=−4.878 and the conditional expression (7) is satisfied. R71/f0=1.312 and the conditional expression (8) is satisfied.

Where R61 is the curvature radius of the lens surface 61 on the object side of the sixth lens 60 (object-side lens) and R62 is the curvature radius of the lens surface 62 on the image side of the sixth lens 60 (object-side lens), the imaging optical system 100 satisfies the following conditional expression:

$$0. < ( R 61 + R 62 ) / ( R 61 - R 62 ) < 1. . \qquad ( 9 )$$

In the present embodiment,

$$R 61 = - 6.507 , and$$

$$R 62 = 1.75 .$$

Therefore, (R61+R62)/(R61-R62)=0.576 and the conditional expression (9) is satisfied.

Where f0 is the focal length of the entire lens system and d0 is the total length of the entire lens system, the imaging optical system 100 satisfies the following conditional expression:

$$10. < d 0 / f 0 < 15. . \qquad ( 10 )$$

In the present embodiment,

$$f 0 = 1.334 , and$$

$$d 0 = 16.77 .$$

Therefore, d0/f0=12.572 and the conditional expression (10) is satisfied.

Where R51 is the curvature radius of the lens surface 51 on the object side of the fifth lens 50 and R52 is the curvature radius of the lens surface 52 on the image side of the fifth lens 50, the imaging optical system 100 satisfies the following conditional expression:

$$\vert R 52 \vert < \vert R 51 \vert . \qquad ( 11 )$$

In the present embodiment,

$$R 51 = 4.99 , and$$

$$R 52 = - 3.75 .$$

Therefore, the conditional expression (11) is satisfied.

Where ν6 is the Abbe number of the sixth lens 60 and ν7 is the Abbe number of the seventh lens 70, the imaging optical system 100 satisfies the following conditional expressions:

$$v 6 < 30. , and \qquad ( 12 )$$

$$50. < v 7. \qquad ( 13 )$$

In the present embodiment,

$$v 6 = 21.621 , and$$

$$v 7 = 56.131 .$$

Therefore, ν6=21.621 and the conditional expression (12) is satisfied. ν7=56.131 and the conditional expression (13) is satisfied.

Where ω is the maximum angle of view, the imaging optical system 100 satisfies the following conditional expression:

$$90 < ω < 120. \qquad ( 14 )$$

In the present embodiment,

$$ω = 106.$$

Therefore, the conditional expression (14) is satisfied.

Where T1 is the thickness of the first lens 10 and f0 is the focal length of the entire lens system, the imaging optical system 100 satisfies the following conditional expression:

$$0.7 < T 1 / f 0 < 0.9 . \qquad ( 15 )$$

In the present embodiment,

$$T 1 = 1. , and$$

$$f 0 = 1.334 .$$

Therefore, T1/f0=0.750 and the conditional expression (15) is satisfied.

Where f0 is the focal length of the entire lens system and R31 is the curvature radius of the lens surface 31 on the object side of the third lens 30 (second group first lens), the imaging optical system 100 satisfies the following conditional expression:

$$8. < \vert R 31 / f 0 \vert . \qquad ( 16 )$$

In the present embodiment,

$$f 0 = 1.334 , and$$

$$R 31 = 15.08 .$$

Therefore, |R31/f0|=11.305 and the conditional expression (16) is satisfied.

Where f0 is the focal length of the entire lens system and f67 is the focal length of the cemented lens 75, the imaging optical system 100 satisfies the following conditional expression:

$$2. < f 67 / f 0 < 7. . \qquad ( 17 )$$

In the present embodiment,

$$f 0 = 1.334 , and$$

$$f 67 = 6.701 .$$

Therefore, f67/f0=5.024 and the conditional expression (17) is satisfied.

### Operation Effect

Since the imaging optical system 100 of the present embodiment satisfies the conditional expressions (1), (1A), (2), (2A), and (3), it is possible to satisfactorily correct the chromatic aberration in the third lens 30 and the fourth lens 40. In a case where the conditional expressions (1), (1A), (2), and (2A) are satisfied, when the value of the conditional expression (3) exceeds the upper limit, since the lens power of the fourth lens 40 becomes too large, it is difficult to satisfactorily correct the chromatic aberration. Here, when the value of the conditional expression (1A) is less than the lower limit, it is possible to satisfactorily correct the chromatic aberration, but the cost of the glass material of the third lens 30 increases.

Since the imaging optical system 100 of the present embodiment satisfies the conditional expressions (1), (1A), (2), (2A), and (4), it is possible to satisfactorily correct the chromatic aberration in the cemented lens 75. In a case where the conditional expressions (1), (1A), (2), and (2A) are satisfied, when the value of the conditional expression (4) is less than the lower limit, since the lens surface 62 and the lens surface 71 that are the cemented surfaces of the cemented lens 75 become closer to a planar shape, it is difficult to satisfactorily correct the chromatic aberration in the cemented lens 75. When the value of the conditional expression (4) exceeds the upper limit, it is possible to satisfactorily correct the chromatic aberration in the cemented lens 75. However, since the sag amounts of the lens surface 62 and the lens surface 71 become too large with respect to the effective radius, the productivity of the sixth lens 60 and the seventh lens 70 decreases and the cost increases. In particular, in a case where the lens surface 71 on the object side La of the seventh lens 70 has a convex shape, when the sag amount become too large with respect to the effective radius, the lens surface 71 largely protrudes. Therefore, when the seventh lens is molded by a mold, it takes a long time for resin flowing from the gate set on the side surface of the flange portion of the seventh lens 70 to be filled up to the top of the lens surface 71. As a result, the productivity of the seventh lens 70 tends to be greatly reduced.

Since the imaging optical system 100 of the present embodiment satisfies the conditional expression (5), it is possible to suppress the occurrence of a ghost on the lens surface 31 on the object side of the third lens 30 while satisfactorily correcting various aberrations. When the value of the conditional expression (5) is less than the lower limit, since the lens surface 31 becomes a flat surface, it is difficult to satisfactorily correct various aberrations. When the value of the conditional expression (5) exceeds the upper limit, a ghost tends to occur on the lens surface 31.

Since the imaging optical system 100 of the present embodiment satisfies the conditional expression (6), it is possible to satisfactorily correct the various aberrations.

Since the imaging optical system 100 of the present embodiment satisfies the conditional expressions (7) and (8), it is possible to satisfactorily correct the various aberrations. When the value of the conditional expression (7) is less than the lower limit, since the curvature radius of the lens surface 61 on the object side of the sixth lens 60 becomes too small, it is difficult to satisfactorily correct various aberrations. When the value of the conditional expression (7) exceeds the upper limit, since the curvature radius of the lens surface 61 on the object side of the sixth lens 60 becomes too large, the productivity of the sixth lens 60 decreases and the cost increases. When the value of the conditional expression (8) is less than the lower limit, since the curvature radius of the lens surface 71 on the object side of the seventh lens 70 becomes too large, the productivity of the seventh lens 70 decreases and the cost increases. When the value of the conditional expression (8) exceeds the upper limit, since the curvature radius of the lens surface 71 on the object side of the seventh lens 70 becomes too small, it is difficult to satisfactorily correct the various aberrations.

Since the imaging optical system 100 of the present embodiment satisfies the conditional expression (9), it is possible to satisfactorily correct the various aberrations.

Since the imaging optical system 100 of the present embodiment satisfies the conditional expression (10), it is possible to suppress an increase in the total length of the entire lens system and to satisfactorily correct the various aberrations. When the value of the conditional expression (10) is less than the lower limit value, it is difficult to satisfactorily correct the various aberrations. When the value of the conditional expression (10) exceeds the upper limit value, each lens system tends to be large and the total length of the entire lens system tends to be large.

The fifth lens 50 is made of glass. Since the imaging optical system 100 of the present embodiment satisfies the conditional expression (11), even when the fifth lens 50 adjacent to the diaphragm 130 on the image side Lb is subjected to a temperature change, it is possible to suppress a decrease in the optical characteristics of the fifth lens 50.

Since the imaging optical system 100 of the present embodiment satisfies the conditional expressions (12) and (13), the cemented lens 75 can satisfactorily correct the chromatic aberration.

Since the imaging optical system 100 of the present embodiment satisfies the conditional expression (14), the imaging apparatus 200 using the imaging optical system 100 can image a wide range and can suppress a large decrease in a peripheral light amount with respect to a central light amount.

Since the imaging optical system 100 of the present embodiment satisfies the conditional expression (15), it is possible to suppress an increase in the total length of the entire lens system while ensuring the strength of the first lens 10. When the value of the conditional expression (15) is less than the lower limit, since the thickness of the first lens 10 becomes too thin, the strength of the first lens 10 decreases. When the value of the conditional expression (15) exceeds the upper limit, the strength of the first lens 10 can be secured, but the total length of the entire lens system tends to increase.

Since the imaging optical system 100 of the present embodiment satisfies the conditional expression (16), it is possible to suppress the production cost of the third lens 30. When the value of the conditional expression (16) is less than the lower limit, since the curvature radius of the lens surface 31 on the object side of the third lens 30 becomes too large, the productivity of the third lens 30 decreases and the cost increases.

Since the imaging optical system 100 of the present embodiment satisfies the conditional expression (17), it is possible to suppress an increase in the total length of the entire lens system and to satisfactorily correct the various aberrations. When the value of the conditional expression (17) is less than the lower limit, it is difficult to satisfactorily correct the chromatic aberration and the distortion aberration in the cemented lens 75. When the value of the conditional expression (17) exceeds the upper limit, the total length of the entire lens system tends to increase.

The third lens 30 has positive power. The lens surface 31 on the object side La of the third lens 30 has a convex shape in the vicinity of the optical axis L and a concave shape in the periphery. The third lens 30 has a convex shape on the lens surface 32 on the image side Lb. As a result, astigmatism and distortion can be satisfactorily corrected.

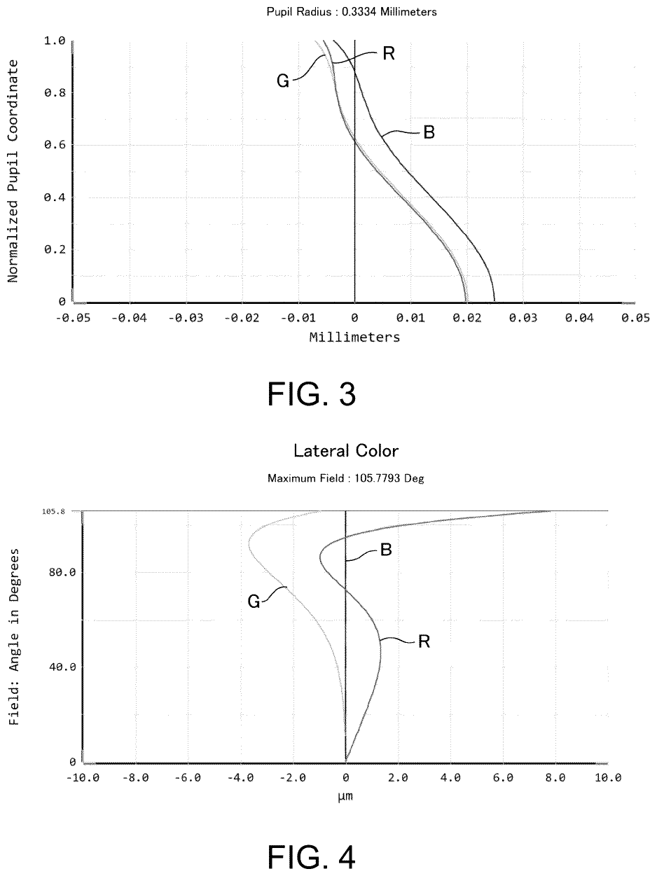

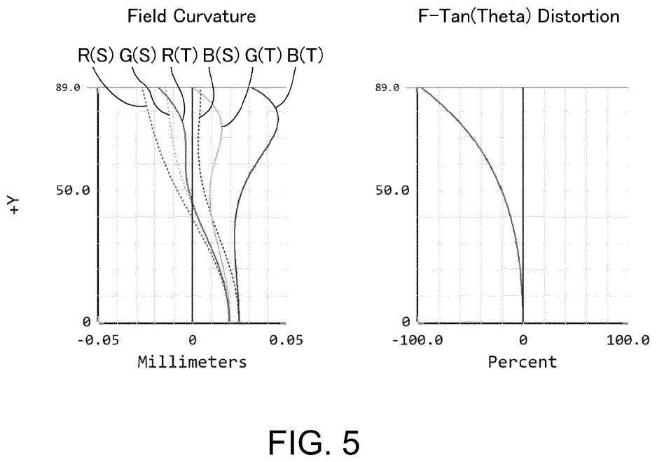

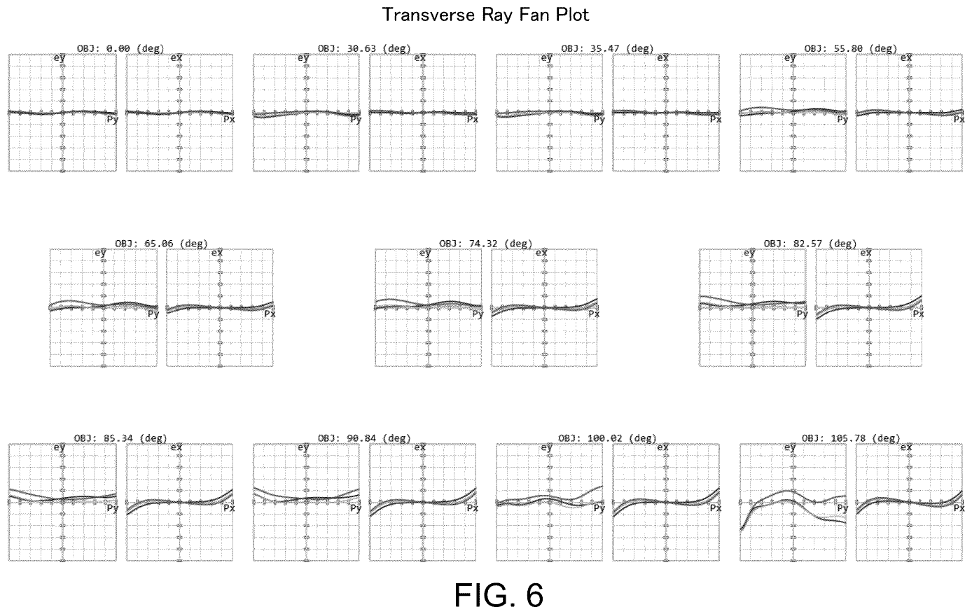

FIG. 3 is a diagram showing the spherical aberration of the imaging optical system 100 shown in FIG. 1. FIG. 4 is a diagram showing the chromatic aberration of magnification of the imaging optical system 100 shown in FIG. 1, and shows the chromatic aberration of magnification at the maximum half angle of view. FIG. 5 is a diagram showing the astigmatism and the distortion of the imaging optical system 100 shown in FIG. 1. FIG. 6 is a diagram showing the lateral aberration of the imaging optical system 100 shown in FIG. 1, and shows the lateral aberration in a tangential direction (Y direction) and a sagittal direction (X direction).

In FIGS. 3 to 6, aberrations at wavelengths of 486 nm, 546 nm, and 656 nm are denoted by B, G, and R, respectively. As for the astigmatism shown in FIG. 5, the characteristic in the sagittal direction is denoted by S, and the characteristic in the tangential direction is denoted by T.

As shown in FIGS. 3 to 6, in the imaging optical system 100 of the present embodiment, the spherical aberration, the chromatic aberration of magnification, the astigmatism (distortion), and the lateral aberration are corrected to appropriate levels.

### Embodiment 2

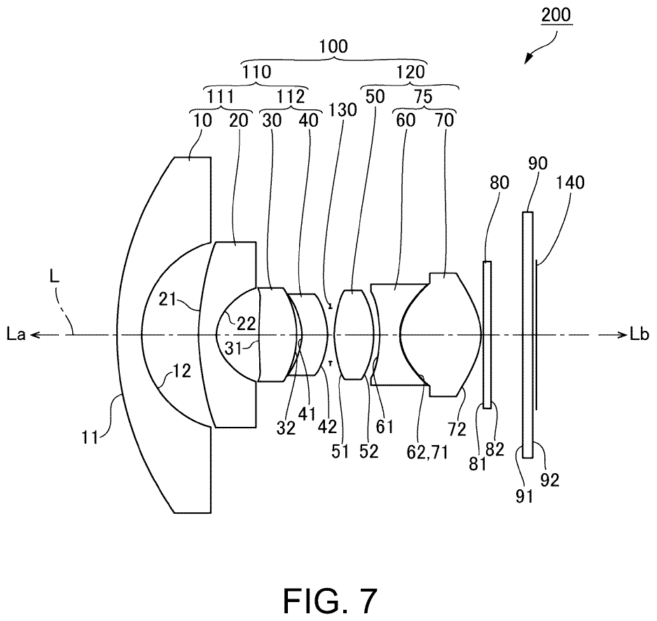

FIG. 7 is an explanatory diagram of an imaging apparatus 200 according to Embodiment 2. As shown in FIG. 7, the imaging apparatus 200 of the present embodiment includes an imaging optical system 100 and an imaging element 140 as in Embodiment 1. A front group 110 consists of, in order from an object side La to an image side Lb, a first lens 10, a second lens 20, a third lens 30 and a fourth lens 40. A rear group 120 consists of, in order from the object side La to the image side Lb, a fifth lens 50, a sixth lens 60 and a seventh lens 70. The sixth lens 60 and the seventh lens 70 construct a cemented lens 75 in which the sixth lens 60 and the seventh lens 70 are cemented by an adhesive. On the image side Lb of the seventh lens 70, a plate-like infrared cut filter 80, a translucent cover 90, and the imaging element 140 are disposed in order from the object side La to the image side Lb. The imaging element 140 is disposed on an imaging plane on the image side Lb of the imaging optical system 100.

The front group 110 includes, in order from the object side La to the image side Lb, a first group 111 having negative power and a second group 112 having positive power. The first group 111 consists of, in order from the object side La to the image side Lb, the first lens 10 and the second lens 20. The first lens 10 is made of glass. The first lens 10 has negative power. The first lens 10 has a convex shape on a lens surface 11 on the object side La and has a concave shape on a lens surface 12 on the image side Lb. The second lens 20 is made of resin. The second lens 20 has negative power. The second lens 20 has a convex shape on a lens surface 21 on the object side La and has a concave shape on a lens surface 22 on the image side Lb. The second lens 20 has an aspherical shape on both surfaces.

The second group 112 consists of, in order from the object side La to the image side Lb, the third lens 30 (second group first lens) and the fourth lens 40 (second group second lens). The third lens 30 is made of resin. The third lens 30 has positive power. The third lens 30 has a convex shape in the vicinity of an optical axis L and a concave shape in the periphery of the lens surface 31 on the object side La, and has a convex shape on the lens surface 32 on the image side Lb. The third lens 30 has an aspherical shape on both surfaces. The fourth lens 40 is made of resin. The fourth lens 40 has negative power. The fourth lens 40 has a concave shape on a lens surface 41 on the object side La, and has a convex shape on a lens surface 42 on the image side Lb. The fourth lens 40 has an aspherical shape on both surfaces.

The rear group 120 consists of, in order from the object side La to the image side Lb, the fifth lens 50 and the cemented lens 75. The cemented lens 75 consists of, in order from the object side La to the image side Lb, the sixth lens 60 (object-side lens) and the seventh lens 70 (image-side lens). The sixth lens 60 and the seventh lens 70 are cemented by an adhesive.

The fifth lens 50 is made of glass. The fifth lens 50 has positive power. The fifth lens 50 has a convex shape on a lens surface 51 on the object side La and has a convex shape on a lens surface 52 on the image side Lb. The sixth lens 60 is made of resin. The sixth lens 60 has negative power. The sixth lens 60 has a concave shape on a lens surface 61 on the object side La and has a concave shape on a lens surface 62 on the image side Lb. The sixth lens 60 has an aspherical shape on both surfaces. The seventh lens 70 is made of resin. The seventh lens 70 has positive power. The seventh lens 70 has a convex shape on a lens surface 71 on the object side La and has a convex shape on a lens surface 72 on the image side Lb. The seventh lens 70 has an aspherical shape on both surfaces.

### Lens Configuration

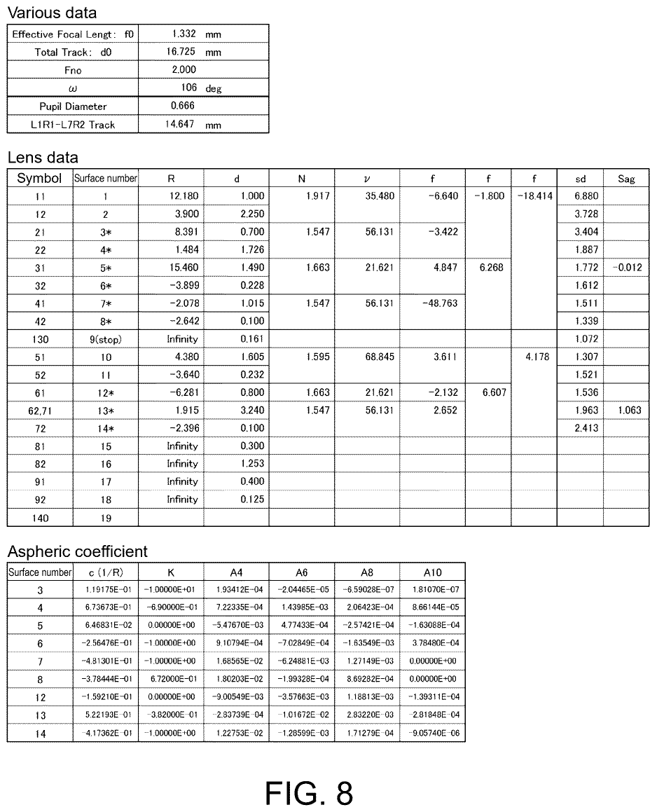

FIG. 8 is a diagram showing data of the imaging optical system 100 of Embodiment 2. The imaging optical system 100 of the present embodiment satisfies the conditional expressions (1) to (17) described in Embodiment 1.

In the present embodiment,

$$v 21 = 21.6 \; 21$$

$$v 22 = 56.131$$

$$f 3 = 4.8 \; 47 , and$$

$$f 4 = - 48.763 .$$

Therefore, ν21=21.621 and the conditional expressions (1) and (1A) are satisfied. ν22=56.131 and the conditional expressions (2) and (2A) are satisfied. |f3/f4|=0.099 and the conditional expression (3) is satisfied.

In the present embodiment,

$$v 21 = 21.6 \; 21$$

$$v 22 = 56.131$$

$$Sag 71 = 1.0 \; 63 , and$$

$$sd 71 = 1.963 .$$

Therefore, ν21=21.621 and the conditional expressions (1) and (1A) are satisfied. ν22=56.131 and the conditional expressions (2) and (2A) are satisfied. |Sag 71/sd71|=0.542 and the conditional expressions (4) and (4A) are satisfied.

In the present embodiment,

$$Sag 31 = - 0.0 \; 12 , and$$

$$sd 31 = 1. 772 .$$

Therefore, |Sag 31/sd31|=0.007 and the conditional expression (5) is satisfied.

In the present embodiment,

$$f 0 = 1.332 , and$$

$$f 34 = 6.268 .$$

Therefore, f34/f0=4.707 and the conditional expression (6) is satisfied.

In the present embodiment,

$$f 0 = 1.332$$

$$R 61 = - 6.2 \; 81 , and$$

$$R 71 = 1. 915 .$$

Therefore, R61/f0=4.717 and the conditional expression (7) is satisfied. R71/f0=1.438 and the conditional expression (8) is satisfied.

In the present embodiment,

$$R 61 = - 6.2 \; 81 , and$$

$$R 62 = 1.915 .$$

Therefore, (R61+R62)/(R61-R62)=0.533 and the conditional expression (9) is satisfied.

In the present embodiment,

$$f 0 = 1.3 \; 32 , and$$

$$d 0 = 16.725 .$$

Therefore, d0/f0=12.559 and the conditional expression (10) is satisfied.

In the present embodiment,

$$R 51 = 4.3 \; 80 , and$$

$$R 52 = - 3.640 .$$

Therefore, the conditional expression (11) is satisfied.

In the present embodiment,

$$v 6 = 21.621 , and$$

$$v 7 = 56.131 .$$

Therefore, ν6=21.621 and the conditional expression (12) is satisfied. ν7=56.131 and the conditional expression (13) is satisfied.

In the present embodiment,

$$ω = 106 .$$

Therefore, the conditional expression (14) is satisfied.

In the present embodiment,

$$T 1 = 1. , and$$

$$f 0 = 1.332 .$$

Therefore, T1/f0=0.751 and the conditional expression (15) is satisfied.

In the present embodiment,

$$f 0 = 1.3 \; 32 , and$$

$$R 31 = 15.460 .$$

Therefore, |R31/f0|=11.610 and the conditional expression (16) is satisfied.

In the present embodiment,

$$f 0 = 1.3 \; 32 , and$$

$$f 67 = 6.607 .$$

Therefore, f67/f0=4.961 and the conditional expression (17) is satisfied.

### Operation Effect

Since the imaging optical system 100 of Embodiment 2 satisfies the conditional expressions (1) to (17) as in Embodiment 1, the same effects as those of Embodiment 1 can be achieved.

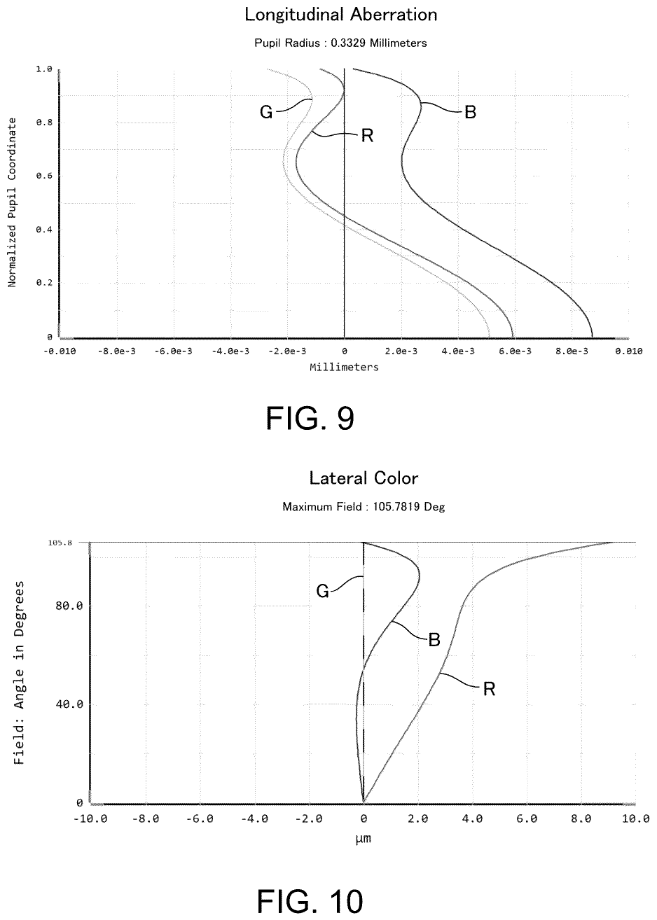

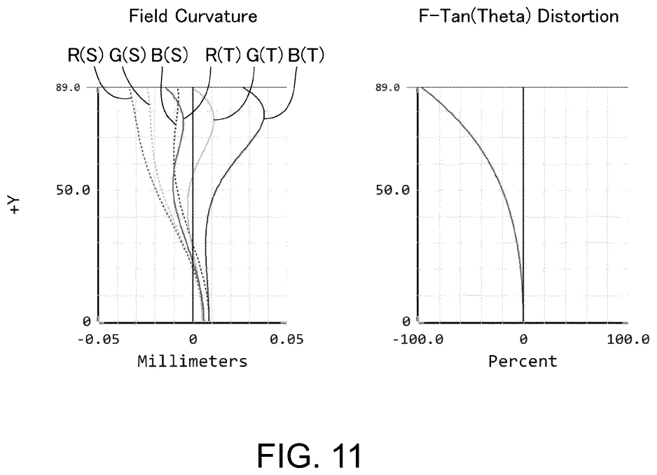

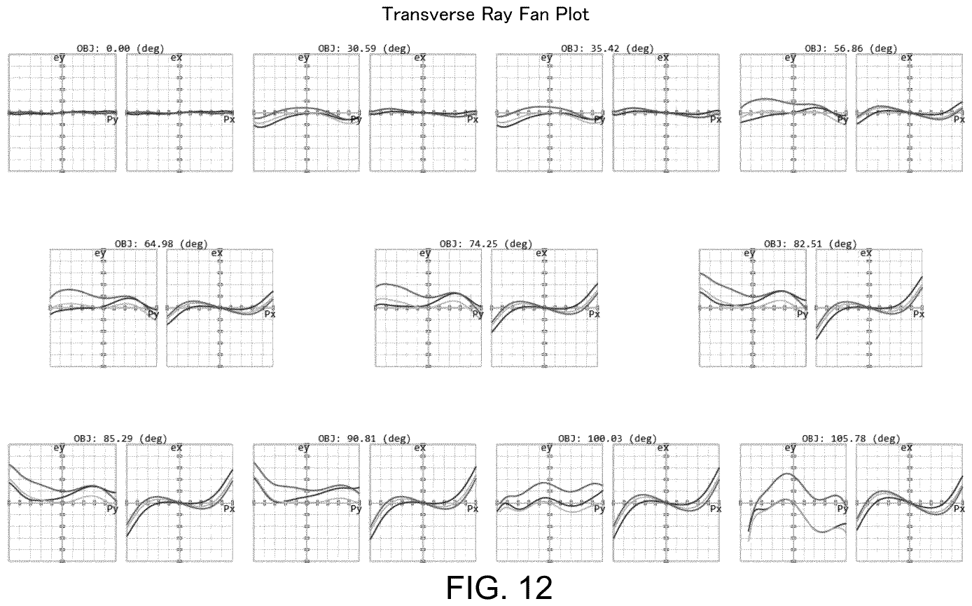

FIG. 9 is a diagram showing the spherical aberration of the imaging optical system 100 shown in FIG. 7. FIG. 10 is a diagram showing the chromatic aberration of magnification of the imaging optical system 100 shown in FIG. 7. FIG. 11 is a diagram showing the astigmatism and the distortion of the imaging optical system 100 shown in FIG. 7. FIG. 12 is a diagram showing the lateral aberration of the imaging optical system 100 shown in FIG. 7.

As shown in FIGS. 9 to 12, in the imaging optical system 100 of the present embodiment, the spherical aberration, the chromatic aberration of magnification, the astigmatism (distortion), the lateral aberration, and the resolution are corrected to appropriate levels.

### Embodiment 3

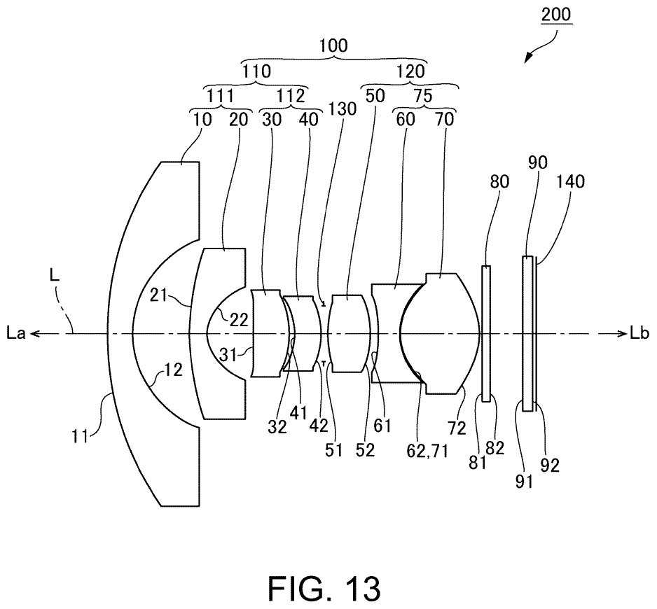

FIG. 13 is an explanatory diagram of an imaging apparatus 200 according to Embodiment 3. As shown in FIG. 13, the imaging apparatus 200 of the present embodiment includes an imaging optical system 100 and an imaging element 140 as in Embodiment 1. A front group 110 consists of, in order from an object side La to an image side Lb, a first lens 10, a second lens 20, a third lens 30 and a fourth lens 40. A rear group 120 consists of, in order from the object side La to the image side Lb, a fifth lens 50, a sixth lens 60 and a seventh lens 70. The sixth lens 60 and the seventh lens 70 construct a cemented lens 75 in which the sixth lens 60 and the seventh lens 70 are cemented by an adhesive. On the image side Lb of the seventh lens 70, a plate-like infrared cut filter 80, a translucent cover 90, and the imaging element 140 are disposed in order from the object side La to the image side Lb. The imaging element 140 is disposed on an imaging plane on the image side Lb of the imaging optical system 100.

The front group 110 includes, in order from the object side La to the image side Lb, a first group 111 having negative power and a second group 112 having positive power. The first group 111 consists of, in order from the object side La to the image side Lb, the first lens 10 and the second lens 20. The first lens 10 is made of glass. The first lens 10 has negative power. The first lens 10 has a convex shape on a lens surface 11 on the object side La and has a concave shape on a lens surface 12 on the image side Lb. The second lens 20 is made of resin. The second lens 20 has negative power. The second lens 20 has a convex shape on a lens surface 21 on the object side La and has a concave shape on a lens surface 22 on the image side Lb. The second lens 20 has an aspherical shape on both surfaces.

The second group 112 consists of, in order from the object side La to the image side Lb, the third lens 30 (second group first lens) and the fourth lens 40 (second group second lens). The third lens 30 is made of resin. The third lens 30 has positive power. The third lens 30 has a convex shape in the vicinity of an optical axis L and a concave shape in the periphery of a lens surface 31 on the object side La, and has a convex shape on a lens surface 32 on the image side Lb. The third lens 30 has an aspherical shape on both surfaces. The fourth lens 40 is made of resin. The fourth lens 40 has negative power. The fourth lens 40 has a concave shape on a lens surface 41 on the object side La and has a convex shape on a lens surface 42 on the image side Lb. The fourth lens 40 has an aspherical shape on both surfaces.

The rear group 120 consists of, in order from the object side La to the image side Lb, the fifth lens 50 and the cemented lens 75. The cemented lens 75 consists of, in order from the object side La to the image side Lb, the sixth lens 60 (object-side lens) and the seventh lens 70 (image-side lens). The sixth lens 60 and the seventh lens 70 are cemented by an adhesive.

The fifth lens 50 is made of glass. The fifth lens 50 has positive power. The fifth lens 50 has a convex shape on a lens surface 51 on the object side La and has a convex shape on a lens surface 52 on the image side Lb. The sixth lens 60 is made of resin. The sixth lens 60 has negative power. The sixth lens 60 has a concave shape on a lens surface 61 on the object side La and has a concave shape on a lens surface 62 on the image side Lb. The sixth lens 60 has an aspherical shape on both surfaces. The seventh lens 70 is made of resin. The seventh lens 70 has positive power. The seventh lens 70 has a convex shape on a lens surface 71 on the object side La and has a convex shape on a lens surface 72 on the image side Lb. The seventh lens 70 has an aspherical shape on both surfaces.

### Lens Configuration

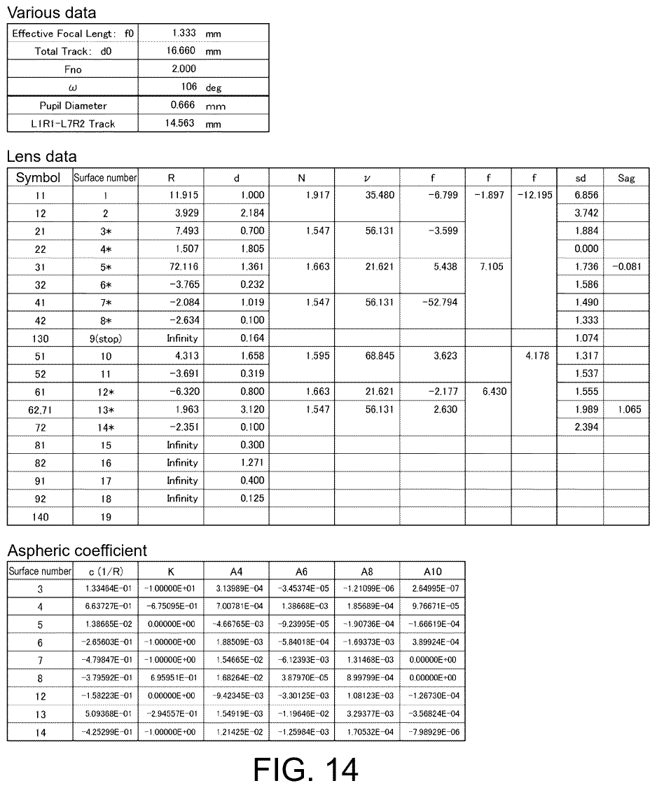

FIG. 14 is a diagram showing data of the imaging optical system 100 of Embodiment 3. The imaging optical system 100 of the present embodiment satisfies the conditional expressions (1) to (17) described in Embodiment 1.

In the present embodiment,

$$v 21 = 21.6 \; 21$$

$$v 22 = 56.131$$

$$f 3 = 5.438 , and$$

$$f 4 = - 52.794 .$$

Therefore, ν21=21.621 and the conditional expressions (1) and (1A) are satisfied. ν22=56.131 and the conditional expressions (2) and (2A) are satisfied. |f3/f4|=0.103 and the conditional expression (3) is satisfied.

In the present embodiment,

$$v 21 = 21.6 \; 21 \\ v 22 = 56.1 \; 31 \\ Sag 71 = 1.0 \; 65 , and$$

$$sd 71 = 1.989 .$$

Therefore, ν21=21.621 and the conditional expressions (1) and (1A) are satisfied. ν22=56.131 and the conditional expressions (2) and (2A) are satisfied. |Sag71/sd71|=0.536 and the conditional expressions (4) and (4A) are satisfied.

In the present embodiment,

$$Sag 31 = - 0.0 \; 81 , and \\ sd 31 = 1.736 .$$

Therefore, |Sag31/sd31|=0.047 and the conditional expression (5) is satisfied.

In the present embodiment,

$$f 0 = 1.3 \; 33 , and \\ f 34 = 7.105 .$$

Therefore, f34/f0=5.332 and the conditional expression (6) is satisfied.

In the present embodiment,

$$f 0 = 1.3 \; 33 \\ R 61 = - 6.3 \; 20 , and \\ R 71 = 1.963 .$$

Therefore, R61/f0=−4.743 and the conditional expression (7) is satisfied. R71/f0=1.473 and the conditional expression (8) is satisfied.

In the present embodiment,

$$R 61 = - 6.3 \; 20 , and \\ R 62 = 1.963 .$$

Therefore, (R61+R62)/(R61-R62)=0.526 and the conditional expression (9) is satisfied.

In the present embodiment,

$$f 0 = 1.3 \; 33 , and \\ d 0 = 16.660 .$$

Therefore, d0/f0=12.502 and the conditional expression (10) is satisfied.

In the present embodiment,

$$R 51 = 4.3 \; 13 , and \\ R 52 = - 3.691 .$$

Therefore, the conditional expression (11) is satisfied.

In the present embodiment,

$$v 6 = 21.6 \; 21 , and \\ v 7 = 56.131 .$$

Therefore, ν6=21.621 and the conditional expression (12) is satisfied. ν7=56.131 and the conditional expression (13) is satisfied.

In the present embodiment,

$$ω = 106 .$$

Therefore, the conditional expression (14) is satisfied.

In the present embodiment,

$$T 1 = 1.0 \; 00 , and \\ f 0 = 1.333 .$$

Therefore, T1/f0=0.750 and the conditional expression (15) is satisfied.

In the present embodiment,

$$f 0 = 1.3 \; 33 , and \\ R 31 = 72.116 .$$

Therefore, |R31/f0|=54.116 and the conditional expression (16) is satisfied.

In the present embodiment,

$$f 0 = 1.3 \; 33 , and \\ f 67 = 6.430 .$$

Therefore, f67/f0=4.825 and the conditional expression (17) is satisfied.

### Operation Effect

Since the imaging optical system 100 of Embodiment 3 satisfies the conditional expressions (1) to (17) as in Embodiment 1, the same effects as those of Embodiment 1 can be achieved.

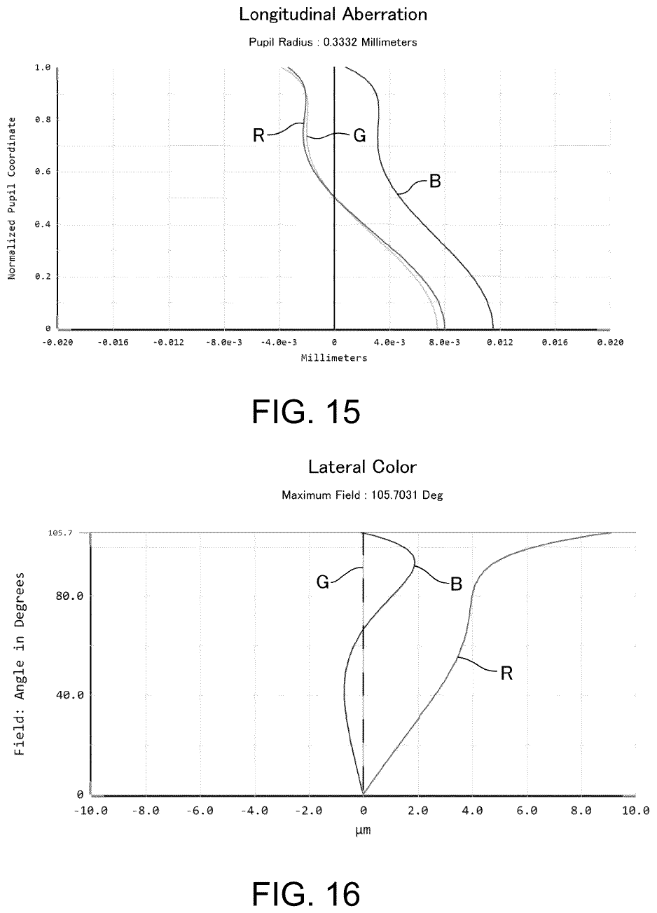

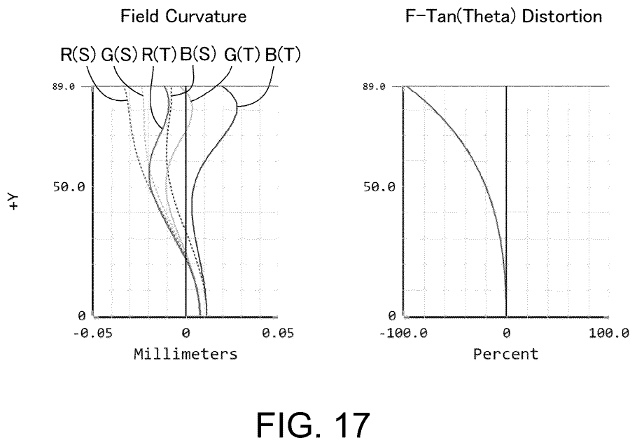

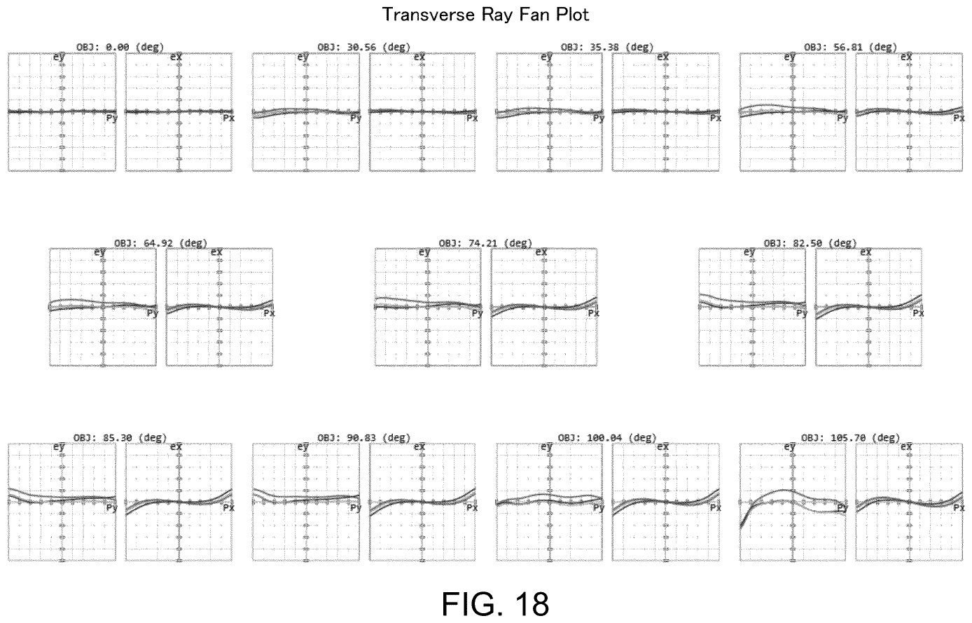

FIG. 15 is a diagram showing the spherical aberration of the imaging optical system 100 shown in FIG. 13. FIG. 16 is a diagram showing the chromatic aberration of magnification of the imaging optical system 100 shown in FIG. 13. FIG. 17 is a diagram showing the astigmatism and the distortion of the imaging optical system 100 shown in FIG. 13. FIG. 18 is a diagram showing the lateral aberration of the imaging optical system 100 shown in FIG. 13.

As shown in FIGS. 15 to 18, in the imaging optical system 100 of the present embodiment, the spherical aberration, the chromatic aberration of magnification, the astigmatism (distortion), the lateral aberration, and the resolution are corrected to appropriate levels.

### Embodiment 4

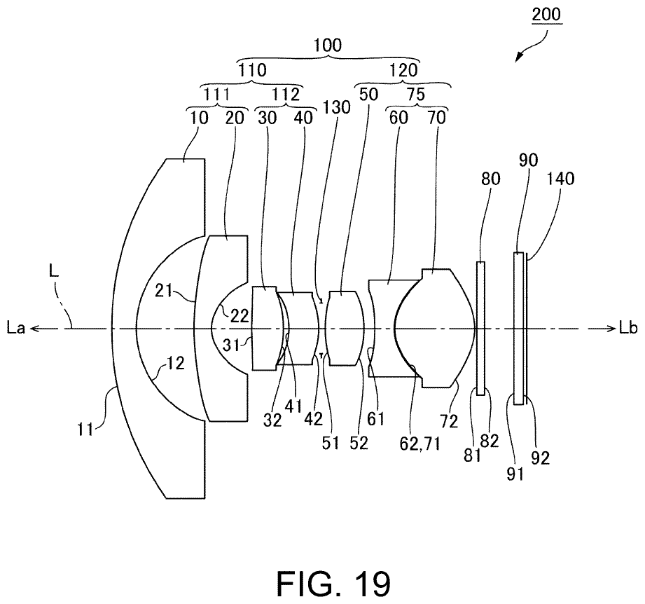

FIG. 19 is an explanatory diagram of an imaging apparatus 200 according to Embodiment 4. As shown in FIG. 19, the imaging apparatus 200 of the present embodiment includes an imaging optical system 100 and an imaging element 140 as in Embodiment 1. A front group 110 consists of, in order from an object side La to an image side Lb, a first lens 10, a second lens 20, a third lens 30 and a fourth lens 40. A rear group 120 consists of, in order from the object side La to the image side Lb, a fifth lens 50, a sixth lens 60 and a seventh lens 70. The sixth lens 60 and the seventh lens 70 construct a cemented lens 75 in which the sixth lens 60 and the seventh lens 70 are cemented by an adhesive. On the image side Lb of the seventh lens 70, a plate-like infrared cut filter 80, a translucent cover 90, and the imaging element 140 are disposed in order from the object side La to the image side Lb. The imaging element 140 is disposed on an imaging plane on the image side Lb of the imaging optical system 100.

The front group 110 includes, in order from the object side La to the image side Lb, a first group 111 having negative power and a second group 112 having positive power. The first group 111 consists of, in order from the object side La to the image side Lb, the first lens 10 and the second lens 20. The first lens 10 is made of glass. The first lens 10 has negative power. The first lens 10 has a convex shape on a lens surface 11 on the object side La and has a concave shape on a lens surface 12 on the image side Lb. The second lens 20 is made of resin. The second lens 20 has negative power. The second lens 20 has a convex shape on a lens surface 21 on the object side La and has a concave shape on a lens surface 22 on the image side Lb. The second lens 20 has an aspherical shape on both surfaces.

The second group 112 consists of, in order from the object side La to the image side Lb, the third lens 30 (second group first lens) and the fourth lens 40 (second group second lens). The third lens 30 is made of resin. The third lens 30 has positive power. The third lens 30 has a convex shape in the vicinity of an optical axis L and a concave shape in the periphery of a lens surface 31 on the object side La, and has a convex shape on a lens surface 32 on the image side Lb. The third lens 30 has an aspherical shape on both surfaces. The fourth lens 40 is made of resin. The fourth lens 40 has negative power. The fourth lens 40 has a concave shape on a lens surface 41 on the object side La and has a convex shape on a lens surface 42 on the image side Lb. The fourth lens 40 has an aspherical shape on both surfaces.

The rear group 120 consists of, in order from the object side La to the image side Lb, the fifth lens 50 and the cemented lens 75. The cemented lens 75 consists of, in order from the object side La to the image side Lb, the sixth lens 60 (object-side lens) and the seventh lens 70 (image-side lens). The sixth lens 60 and the seventh lens 70 are cemented by an adhesive.

The fifth lens 50 is made of glass. The fifth lens 50 has positive power. The fifth lens 50 has a convex shape on a lens surface 51 on the object side La and has a convex shape on a lens surface 52 on the image side Lb. The sixth lens 60 is made of resin. The sixth lens 60 has negative power. The sixth lens 60 has a concave shape on a lens surface 61 on the object side La and has a concave shape on a lens surface 62 on the image side Lb. The sixth lens 60 has an aspherical shape on both surfaces. The seventh lens 70 is made of resin. The seventh lens 70 has positive power. The seventh lens 70 has a convex shape on a lens surface 71 on the object side La and has a convex shape on a lens surface 72 on the image side Lb. The seventh lens 70 has an aspherical shape on both surfaces.

### Lens Configuration

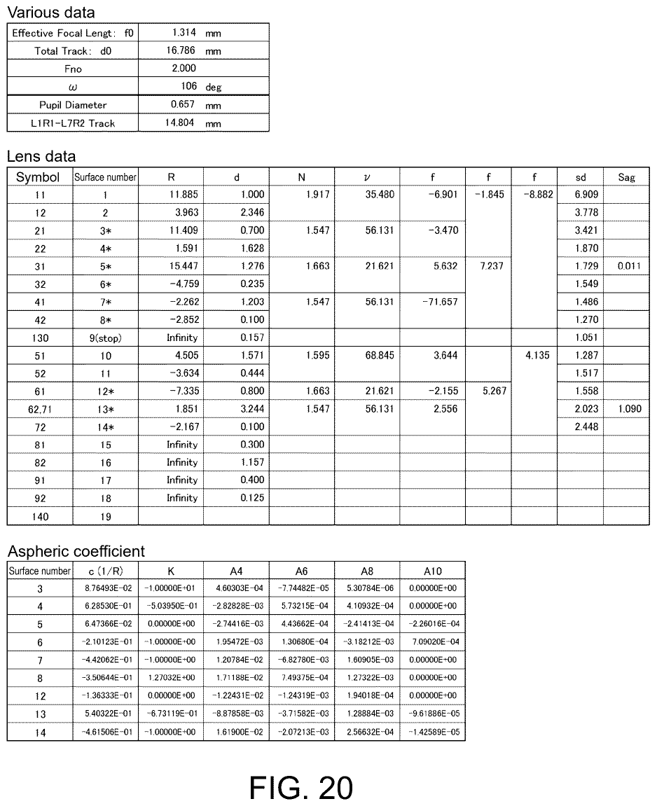

FIG. 20 is a diagram showing data of the imaging optical system 100 of Embodiment 4. The imaging optical system 100 of the present embodiment satisfies the conditional expressions (1) to (17) described in Embodiment 1.

In the present embodiment,

$$v 21 = 21.6 \; 21 \\ v 22 = 56.1 \; 31 \\ f 3 = 5.6 \; 32 , and$$

$$f 4 = - 71.657 .$$

Therefore, ν21=21.621 and the conditional expressions (1) and (1A) are satisfied. ν22=56.131 and the conditional expressions (2) and (2A) are satisfied. |f3/f4|=0.079 and the conditional expression (3) is satisfied.

In the present embodiment,

$$v 21 = 21.6 \; 21 \\ v 22 = 56.1 \; 31 \\ Sag 71 = 1.09 , and$$

$$sd 71 = 2.023 .$$

Therefore, ν21=21.621 and the conditional expressions (1) and (1A) are satisfied. ν22=56.131 and the conditional expressions (2) and (2A) are satisfied. |Sag71/sd71|=0.539 and the conditional expressions (4) and (4A) are satisfied.

In the present embodiment,

$$Sag 31 = 0.0 \; 11 , and \\ sd 31 = 1.729 .$$

Therefore, |Sag 31/sd31|=0.006 and the conditional expression (5) is satisfied.

In the present embodiment,

$$f 0 = 1.314 , and$$

$$f 34 = 7.237 .$$

Therefore, f 34/f0=5.507 and the conditional expression (6) is satisfied.

In the present embodiment,

$$f 0 = 1.314$$

$$R 61 = - 7.335 , and$$

$$R 71 = 1.851 .$$

Therefore, R61/f0=−5.582 and the conditional expression (7) is satisfied. R71/f0=1.408 and the conditional expression (8) is satisfied.

In the present embodiment,

$$R 61 = - 7.335 , and$$

$$R 62 = 1.851 .$$

Therefore, (R61+R62)/(R61-R62)=0.597 and the conditional expression (9) is satisfied.

In the present embodiment,

$$f 0 = 1.314 , and$$

$$d 0 = 16.786 .$$

Therefore, d0/f0=12.773 and the conditional expression (10) is satisfied.

In the present embodiment,

$$R 51 = 4.505 , and$$

$$R 52 = - 3.634 .$$

Therefore, the conditional expression (11) is satisfied.

In the present embodiment,

$$v 6 = 21.621 , and$$

$$v 7 = 56.131 .$$

Therefore, ν6=21.621 and the conditional expression (12) is satisfied. ν7=56.131 and the conditional expression (13) is satisfied.

In the present embodiment,

$$ω = 106.$$

Therefore, the conditional expression (14) is satisfied.

In the present embodiment,

$$T 1 = 1. , and$$

$$f 0 = 1.314 .$$

Therefore, T1/f0=0.761 and the conditional expression (15) is satisfied.

In the present embodiment,

$$f 0 = 1.314 , and$$

$$R 3 = 15.447 .$$

Therefore, |R31/f0|=11.755 and the conditional expression (16) is satisfied.

In the present embodiment,

$$f 0 = 1.314 , and$$

$$f 67 = 5.267 .$$

Therefore, f67/f0=4.008 and the conditional expression (17) is satisfied.

### Operation Effect

Since the imaging optical system 100 of Embodiment 4 satisfies the conditional expressions (1) to (17) as in Embodiment 1, the same effects as those of Embodiment 1 can be achieved.

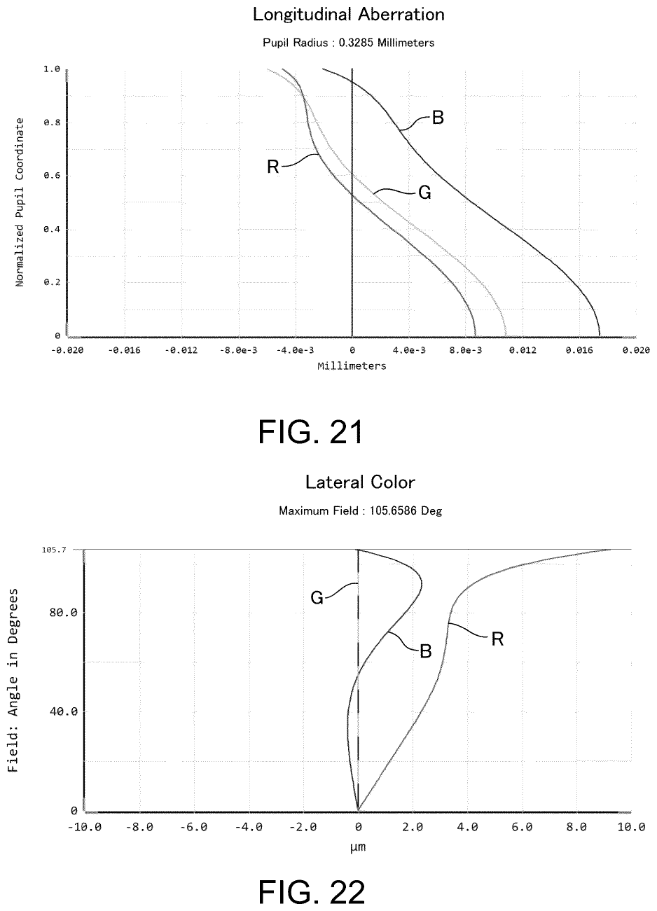

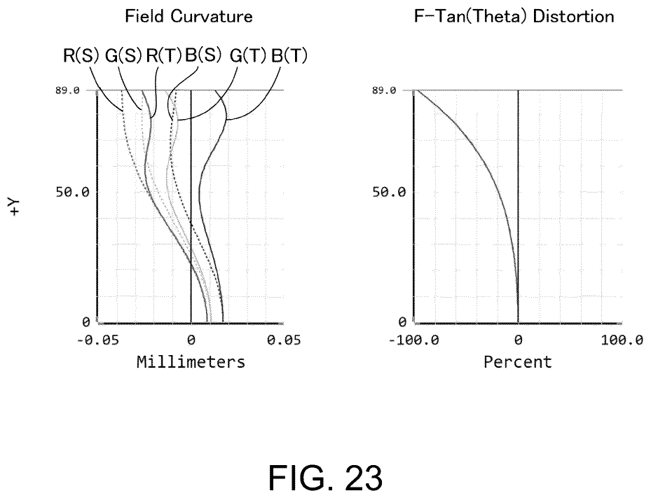

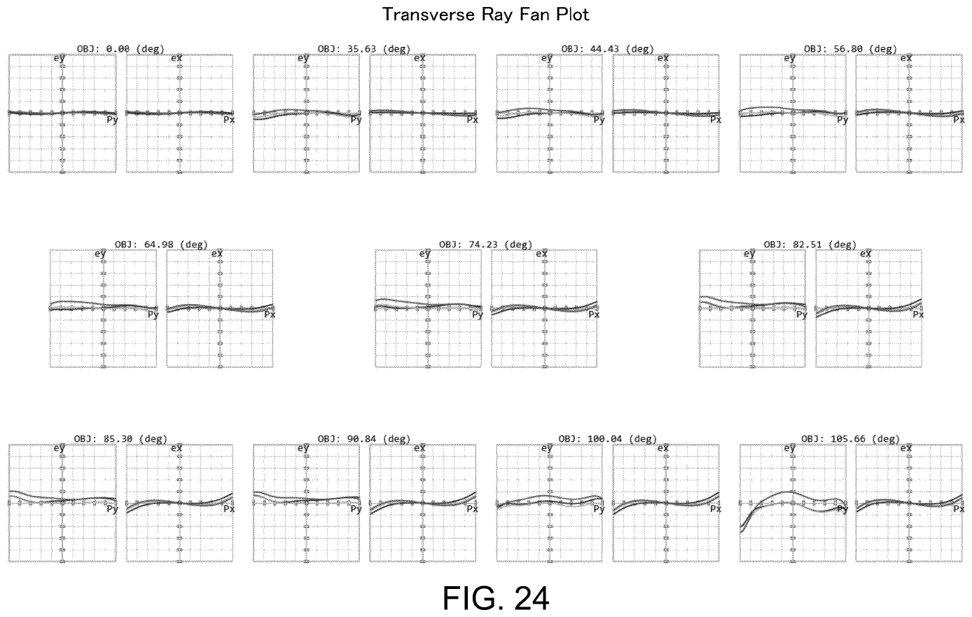

FIG. 21 is a diagram showing the spherical aberration of the imaging optical system 100 shown in FIG. 19. FIG. 22 is a diagram showing the chromatic aberration of magnification of the imaging optical system 100 shown in FIG. 19. FIG. 23 is a diagram showing the astigmatism and the distortion of the imaging optical system 100 shown in FIG. 19. FIG. 24 is a diagram showing the lateral aberration of the imaging optical system 100 shown in FIG. 19.

As shown in FIGS. 21 to 24, in the imaging optical system 100 of the present embodiment, the spherical aberration, the chromatic aberration of magnification, the astigmatism (distortion), the lateral aberration, and the resolution are corrected to appropriate levels.

### Embodiment 5

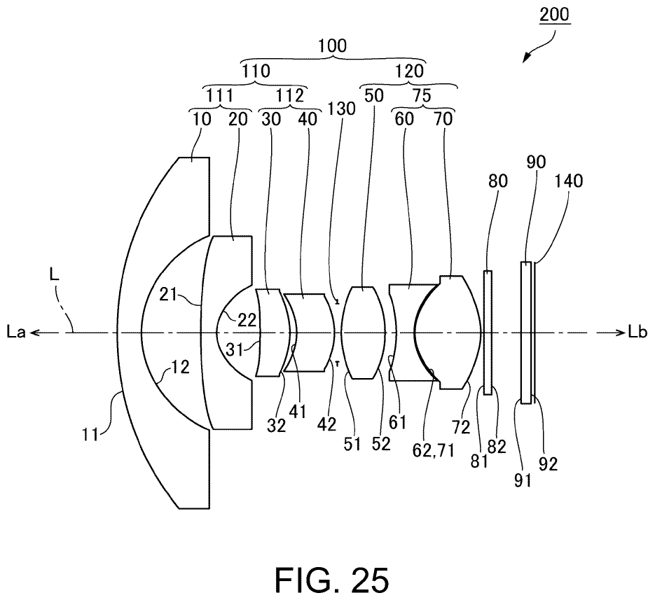

FIG. 25 is an explanatory diagram of an imaging apparatus 200 according to Embodiment 5. As shown in FIG. 25, the imaging apparatus 200 of the present embodiment includes an imaging optical system 100 and an imaging element 140 as in Embodiment 1. A front group 110 consists of, in order from an object side La to an image side Lb, a first lens 10, a second lens 20, a third lens 30 and a fourth lens 40. A rear group 120 consists of, in order from the object side La to the image side Lb, a fifth lens 50, a sixth lens 60 and a seventh lens 70. The sixth lens 60 and the seventh lens 70 construct a cemented lens 75 in which the sixth lens 60 and the seventh lens 70 are cemented by an adhesive. On the image side Lb of the seventh lens 70, a plate-like infrared cut filter 80, a translucent cover 90, and the imaging element 140 are disposed in order from the object side La to the image side Lb. The imaging element 140 is disposed on an imaging plane on the image side Lb of the imaging optical system 100.

The front group 110 includes, in order from the object side La to the image side Lb, a first group 111 having negative power and a second group 112 having positive power. The first group 111 consists of, in order from the object side La to the image side Lb, the first lens 10 and the second lens 20. The first lens 10 is made of glass. The first lens 10 has negative power. The first lens 10 has a convex shape on a lens surface 11 on the object side La and has a concave shape on a lens surface 12 on the image side Lb. The second lens 20 is made of resin. The second lens 20 has negative power. The second lens 20 has a convex shape on a lens surface 21 on the object side La and has a concave shape on a lens surface 22 on the image side Lb. The second lens 20 has an aspherical shape on both surfaces.

The second group 112 consists of, in order from the object side La to the image side Lb, the third lens 30 (second group first lens) and the fourth lens 40 (second group second lens). The third lens 30 is made of resin. The third lens 30 has positive power. The third lens 30 has a concave shape on a lens surface 31 on the object side La and has a convex shape on a lens surface 32 on the image side Lb. The third lens 30 has an aspherical shape on both surfaces. The fourth lens 40 is made of resin. The fourth lens 40 has negative power. The fourth lens 40 has a concave shape on a lens surface 41 on the object side La and has a convex shape on a lens surface 42 on the image side Lb. The fourth lens 40 has an aspherical shape on both surfaces.

The rear group 120 consists of, in order from the object side La to the image side Lb, the fifth lens 50 and the cemented lens 75. The cemented lens 75 consists of, in order from the object side La to the image side Lb, the sixth lens 60 (object-side lens) and the seventh lens 70 (image-side lens). The sixth lens 60 and the seventh lens 70 are cemented by an adhesive.

The fifth lens 50 is made of glass. The fifth lens 50 has positive power. The fifth lens 50 has a convex shape on a lens surface 51 on the object side La and has a convex shape on a lens surface 52 on the image side Lb. The sixth lens 60 is made of resin. The sixth lens 60 has negative power. The sixth lens 60 has a concave shape on a lens surface 61 on the object side La and has a concave shape on a lens surface 62 on the image side Lb. The sixth lens 60 has an aspherical shape on both surfaces. The seventh lens 70 is made of resin. The seventh lens 70 has positive power. The seventh lens 70 has a convex shape on a lens surface 71 on the object side La and has a convex shape on a lens surface 72 on the image side Lb. The seventh lens 70 has an aspherical shape on both surfaces.

### Lens Configuration

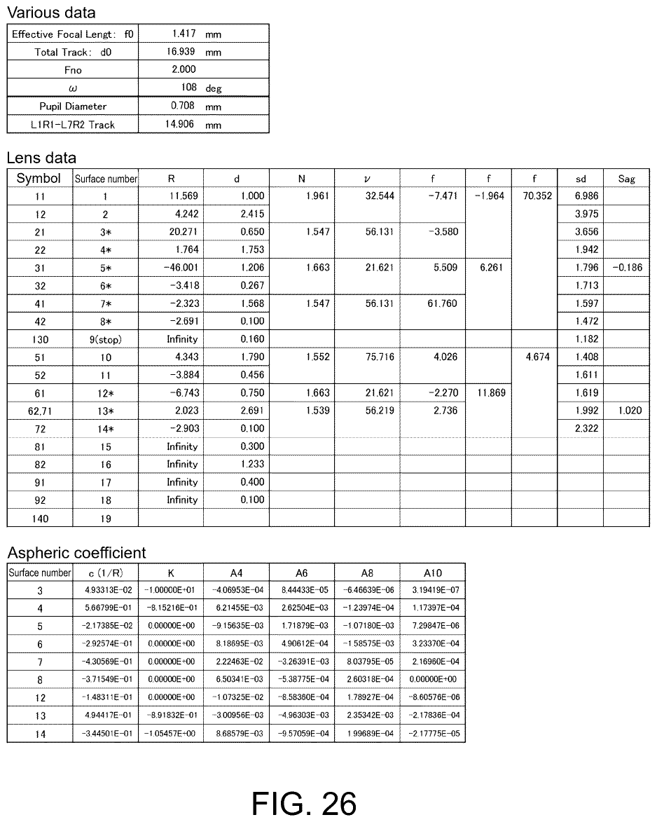

FIG. 26 is a diagram showing data of the imaging optical system 100 of Embodiment 5. The imaging optical system 100 of the present embodiment satisfies the conditional expressions (1) to (16) described in Embodiment 1.

In the present embodiment,

$$v 21 = 21.621$$

$$v 22 = 56.131$$

$$f 3 = 5.509 , and$$

$$f 4 = 61.76 .$$

Therefore, ν21=21.621 and the conditional expressions (1) and (1A) are satisfied. ν22=56.131 and the conditional expressions (2) and (2A) are satisfied. |f3/f4|=0.089 and the conditional expression (3) is satisfied.

In the present embodiment,

$$v 21 = 21.621$$

$$v 22 = 56.131$$

$$Sag 71 = 1.02 , and$$

$$sa 71 = 1.992 .$$

Therefore, ν21=21.621 and the conditional expressions (1) and (1A) are satisfied. ν22=56.131 and the conditional expressions (2) and (2A) are satisfied. |Sag71/sd71|=0.512 and the conditional expressions (4) and (4A) are satisfied.

In the present embodiment,

$$Sag 31 = - 0.186 , and$$

$$sd 31 = 1.796 .$$

Therefore, |Sag31/sd31|=0.104 and the conditional expression (5) is satisfied.

In the present embodiment,

$$f 0 = 1.417 , and$$

$$f 34 = 6.261 .$$

Therefore, f34/f0=4.419 and the conditional expression (6) is satisfied.

In the present embodiment,

$$f 0 = 1.417$$

$$R 61 = - 6.743 , and$$

$$R 71 = 2.023 .$$

Therefore, R61/f0=−4.759 and the conditional expression (7) is satisfied. R71/f0=1.428 and the conditional expression (8) is satisfied.

In the present embodiment,

$$R 61 = - 6.7 \; 43 , and \\ R 62 = 2.023 .$$

Therefore, (R61+R62)/(R61-R62)=0.538 and the conditional expression (9) is satisfied.

In the present embodiment,

$$f 0 = 1.4 \; 17 , and \\ d 0 = 16.939 .$$

Therefore, d0/f0=11.957 and the conditional expression (10) is satisfied.

In the present embodiment,

$$R 51 = 4.3 \; 43 , and \\ R 52 = - 3.884 .$$

Therefore, the conditional expression (11) is satisfied.

In the present embodiment,

$$v 6 = 21.6 \; 21 , and \\ v 7 = 56.219 .$$

Therefore, ν6=21.621 and the conditional expression (12) is satisfied. ν7=56.219 and the conditional expression (13) is satisfied.

In the present embodiment,

$$ω = 108 .$$

Therefore, the conditional expression (14) is satisfied.

In the present embodiment,

$$T 1 = 1.0 \; 00 , and \\ f 0 = 1.417 .$$

Therefore, T1/f0=0.706 and the conditional expression (15) is satisfied.

In the present embodiment,

$$f 0 = 1.4 \; 17 , and \\ R 31 = - 46.001 .$$

Therefore, |R31/f0|=32.470 and the conditional expression (16) is satisfied.

### Operation Effect

Since the imaging optical system 100 of Embodiment 5 satisfies the conditional expressions (1) to (16) as in Embodiment 1, the same effects as those of Embodiment 1 can be achieved.

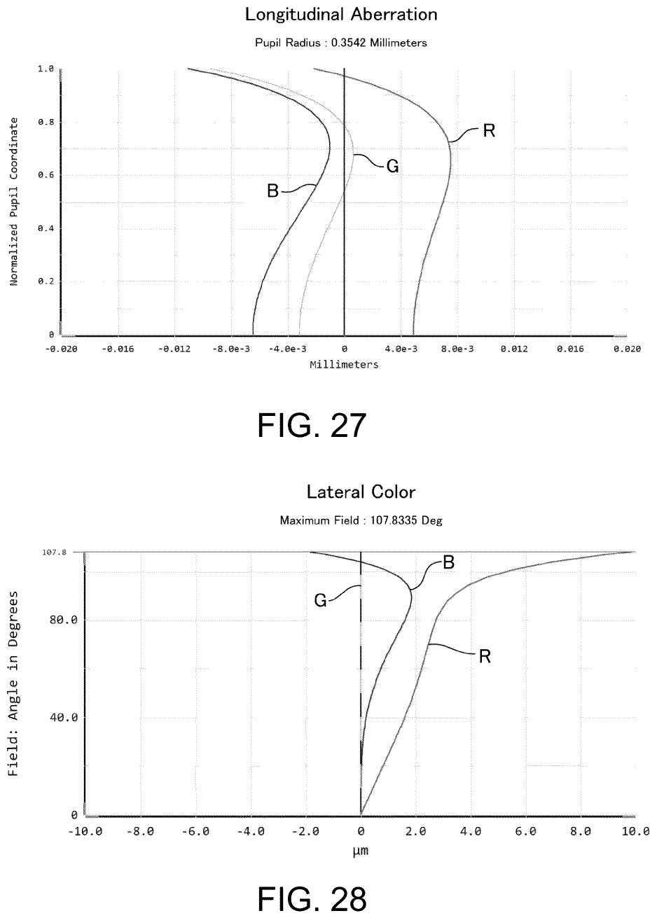

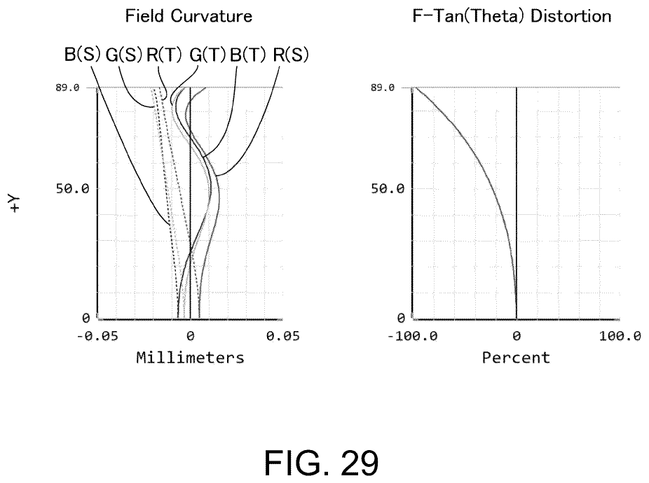

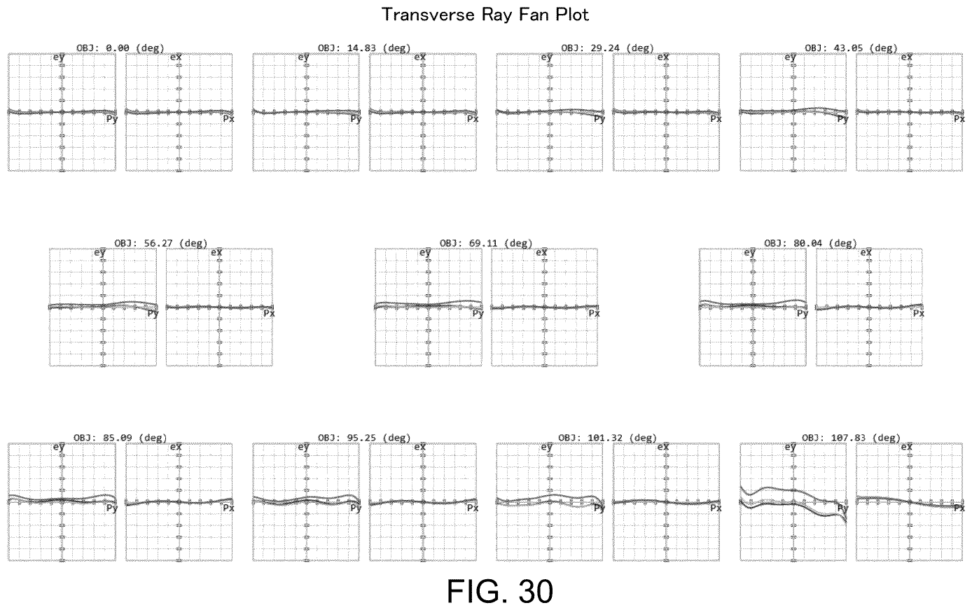

FIG. 27 is a diagram showing the spherical aberration of the imaging optical system 100 shown in FIG. 25. FIG. 28 is a diagram showing the chromatic aberration of magnification of the imaging optical system 100 shown in FIG. 25. FIG. 29 is a diagram showing the astigmatism and the distortion of the imaging optical system 100 shown in FIG. 25. FIG. 30 is a diagram showing the lateral aberration of the imaging optical system 100 shown in FIG. 25.

As shown in FIGS. 27 to 30, in the imaging optical system 100 of the present embodiment, the spherical aberration, the chromatic aberration of magnification, the astigmatism (distortion), the lateral aberration, and the resolution are corrected to appropriate levels.

### Embodiment 6

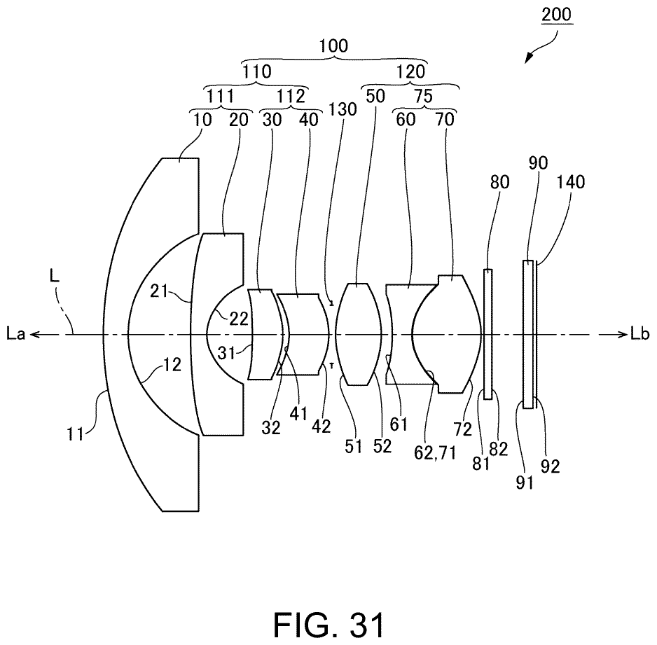

FIG. 31 is an explanatory diagram of an imaging apparatus 200 according to Embodiment 6. As shown in FIG. 31, the imaging apparatus 200 of the present embodiment includes an imaging optical system 100 and an imaging element 140 as in Embodiment 1. A front group 110 consists of, in order from an object side La to an image side Lb, a first lens 10, a second lens 20, a third lens 30 and a fourth lens 40. A rear group 120 consists of, in order from the object side La to the image side Lb, a fifth lens 50, a sixth lens 60 and a seventh lens 70. The sixth lens 60 and the seventh lens 70 construct a cemented lens 75 in which the sixth lens 60 and the seventh lens 70 are cemented by an adhesive. On the image side Lb of the seventh lens 70, a plate-like infrared cut filter 80, a translucent cover 90, and the imaging element 140 are disposed in order from the object side La to the image side Lb. The imaging element 140 is disposed on an imaging plane on the image side Lb of the imaging optical system 100.

The front group 110 includes, in order from the object side La to the image side Lb, a first group 111 having negative power and a second group 112 having positive power. The first group 111 consists of, in order from the object side La to the image side Lb, the first lens 10 and the second lens 20. The first lens 10 is made of glass. The first lens 10 has negative power. The first lens 10 has a convex shape on a lens surface 11 on the object side La and has a concave shape on a lens surface 12 on the image side Lb. The second lens 20 is made of resin. The second lens 20 has negative power. The second lens 20 has a convex shape on a lens surface 21 on the object side La and has a concave shape on a lens surface 22 on the image side Lb. The second lens 20 has an aspherical shape on both surfaces.

The second group 112 consists of, in order from the object side La to the image side Lb, the third lens 30 (second group first lens) and the fourth lens 40 (second group second lens). The third lens 30 is made of resin. The third lens 30 has positive power. The third lens 30 has a concave shape on a lens surface 31 on the object side La and has a convex shape on a lens surface 32 on the image side Lb. The third lens 30 has an aspherical shape on both surfaces. The fourth lens 40 is made of resin. The fourth lens 40 has negative power. The fourth lens 40 has a concave shape on a lens surface 41 on the object side La and has a convex shape on a lens surface 42 on the image side Lb. The fourth lens 40 has an aspherical shape on both surfaces.

The rear group 120 consists of, in order from the object side La to the image side Lb, the fifth lens 50 and the cemented lens 75. The cemented lens 75 consists of, in order from the object side La to the image side Lb, the sixth lens 60 (object-side lens) and the seventh lens 70 (image-side lens). The sixth lens 60 and the seventh lens 70 are cemented by an adhesive.

The fifth lens 50 is made of glass. The fifth lens 50 has positive power. The fifth lens 50 has a convex shape on a lens surface 51 on the object side La and has a convex shape on a lens surface 52 on the image side Lb. The sixth lens 60 is made of resin. The sixth lens 60 has negative power. The sixth lens 60 has a concave shape on a lens surface 61 on the object side La and has a concave shape on a lens surface 62 on the image side Lb. The sixth lens 60 has an aspherical shape on both surfaces. The seventh lens 70 is made of resin. The seventh lens 70 has positive power. The seventh lens 70 has a convex shape on a lens surface 71 on the object side La and has a convex shape on a lens surface 72 on the image side Lb. The seventh lens 70 has an aspherical shape on both surfaces.

### Lens Configuration

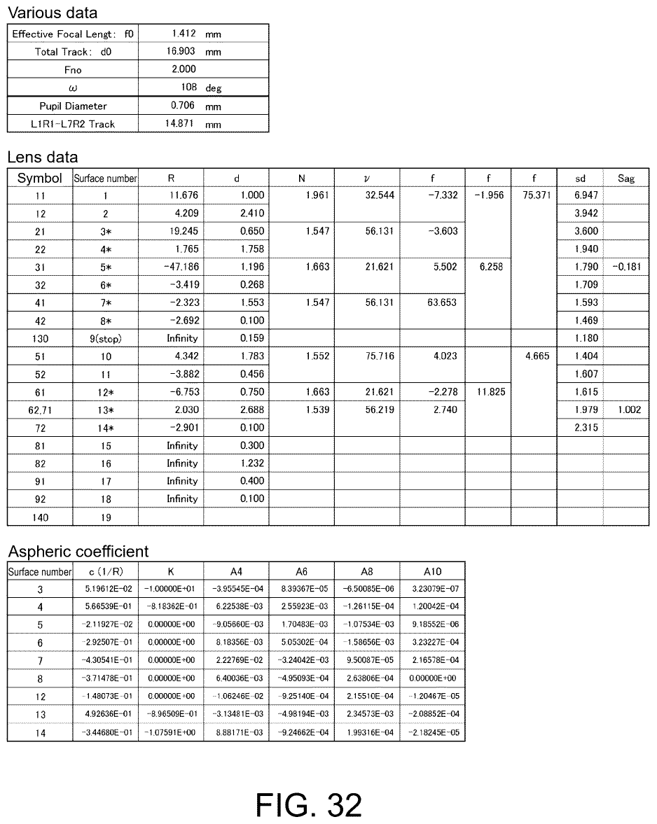

FIG. 32 is a diagram showing data of the imaging optical system 100 of Embodiment 6. The imaging optical system 100 of the present embodiment satisfies the conditional expressions (1) to (16) described in Embodiment 1.

In the present embodiment,

$$v 21 = 21.621 \\ v 22 = 56.131 \\ f 3 = 5.5 \; 02 , and$$

$$f 4 = 63.653 .$$

Therefore, ν21=21.621 and the conditional expressions (1) and (1A) are satisfied. ν22=56.131 and the conditional expressions (2) and (2A) are satisfied. |f3/f4|=0.086 and the conditional expression (3) is satisfied.

In the present embodiment,

$$v 21 = 21.6 \; 21 \\ v 22 = 56.1 \; 31 \\ Sag 71 = 1.0 \; 02 , and$$

$$sd 71 = 1.979 .$$

Therefore, ν21=21.621 and the conditional expressions (1) and (1A) are satisfied. ν22=56.131 and the conditional expressions (2) and (2A) are satisfied. |Sag71/sd71|=0.506 and the conditional expressions (4) and (4A) are satisfied.

In the present embodiment,

$$Sag 31 = - 0.1 \; 81 , and \\ sd 31 = 1.790 .$$

Therefore, |Sag31/sd31|=0.101 and the conditional expression (5) is satisfied.

In the present embodiment,

$$f 0 = 1.4 \; 12 , and \\ f 34 = 6.258 .$$

Therefore, f34/f0=4.432 and the conditional expression (6) is satisfied.

In the present embodiment,

$$f 0 = 1.4 \; 12 \\ R 61 = - 6.7 \; 53 , and \\ R 71 = 2030.$$

Therefore, R61/f0=−4.782 and the conditional expression (7) is satisfied. R71/f0=1.437 and the conditional expression (8) is satisfied.

In the present embodiment,

$$R 61 = - 6.7 \; 53 , and \\ R 71 = 2.03 .$$

Therefore, (R61+R62)/(R61-R62)=0.538 and the conditional expression (9) is satisfied.

In the present embodiment,

$$f 0 = 1.4 \; 12 , and \\ d 0 = 16.903 .$$

Therefore, d0/f0=11.970 and the conditional expression (10) is satisfied.

In the present embodiment,

$$R 51 = 4.3 \; 42 , and \\ R 52 = - 3.882 .$$

Therefore, the conditional expression (11) is satisfied.

In the present embodiment,

$$v 6 = 21.6 \; 21 , and \\ v 7 = 56.219 .$$

Therefore, ν6=21.621 and the conditional expression (12) is satisfied. ν7=56.219 and the conditional expression (13) is satisfied.

In the present embodiment,

$$ω = 108 .$$

Therefore, the conditional expression (14) is satisfied.

In the present embodiment,

$$T 1 = 1.0 \; 00 , and \\ f 0 = 1.412 .$$

Therefore, T1/f0 =0.708 and the conditional expression (15) is satisfied.

In the present embodiment,

$$f 0 = 1.4 \; 12 , and \\ R 31 = - 47.186 .$$

Therefore, |R31/f0|=33.415 and the conditional expression (16) is satisfied.

### Operation Effect

Since the imaging optical system 100 of Embodiment 6 satisfies the conditional expressions (1) to (16) as in Embodiment 1, the same effects as those of Embodiment 1 can be achieved.

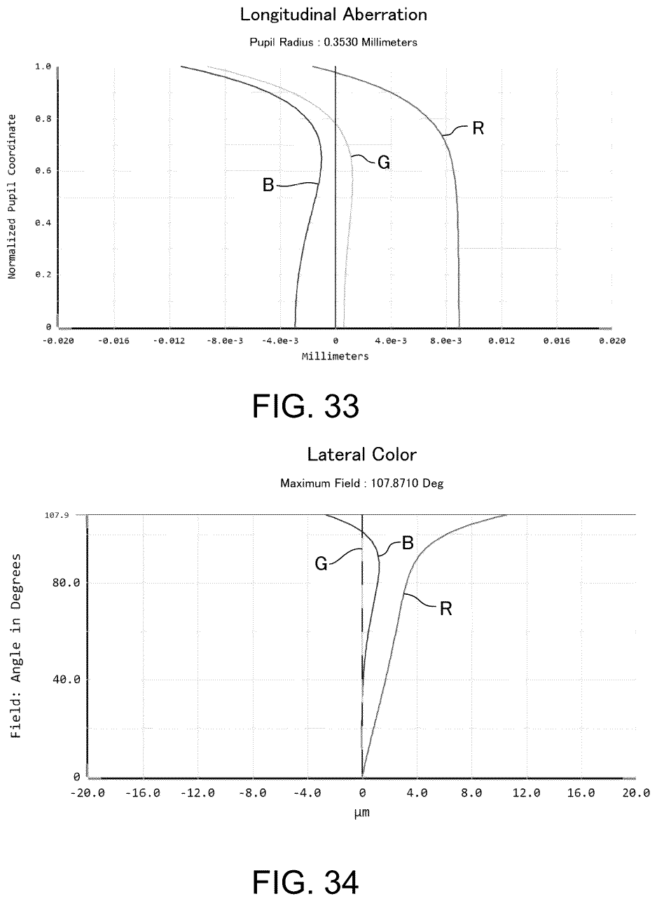

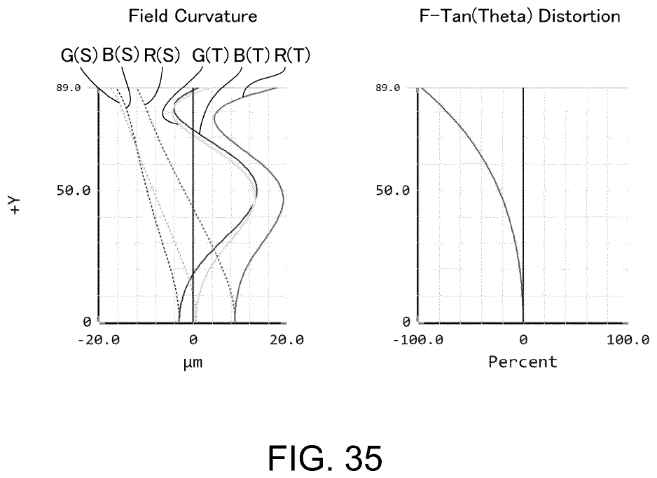

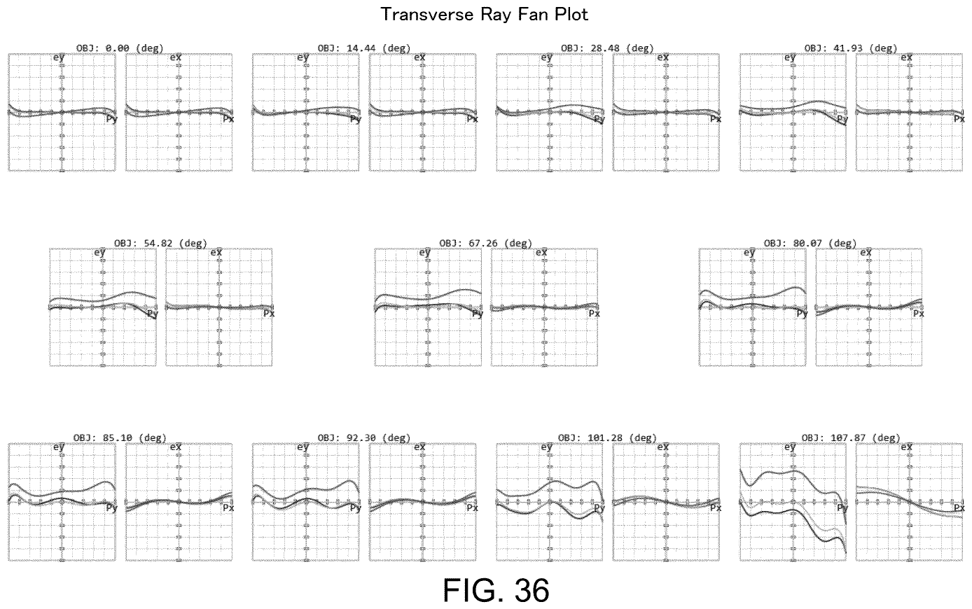

FIG. 33 is a diagram showing the spherical aberration of the imaging optical system 100 shown in FIG. 31. FIG. 34 is a diagram showing the chromatic aberration of magnification of the imaging optical system 100 shown in FIG. 31. FIG. 35 is a diagram showing the astigmatism and the distortion of the imaging optical system 100 shown in FIG. 31. FIG. 36 is a diagram showing the lateral aberration of the imaging optical system 100 shown in FIG. 31.

As shown in FIGS. 33 to 36, in the imaging optical system 100 of the present embodiment, the spherical aberration, the chromatic aberration of magnification, the astigmatism (distortion), the lateral aberration, and the resolution are corrected to appropriate levels.

### Embodiment 7

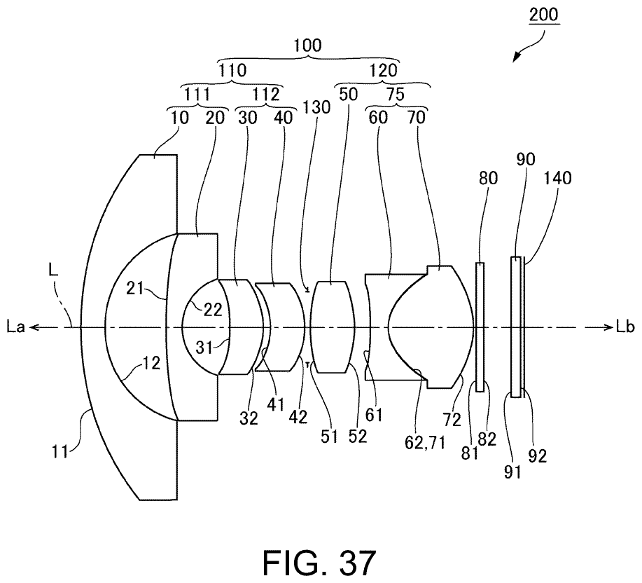

FIG. 37 is an explanatory diagram of an imaging apparatus 200 according to Embodiment 7. As shown in FIG. 37, the imaging apparatus 200 of the present embodiment includes an imaging optical system 100 and an imaging element 140 as in Embodiment 1. A front group 110 consists of, in order from an object side La to an image side Lb, a first lens 10, a second lens 20, a third lens 30 and a fourth lens 40. A rear group 120 consists of, in order from the object side La to the image side Lb, a fifth lens 50, a sixth lens 60 and a seventh lens 70. The sixth lens 60 and the seventh lens 70 construct a cemented lens 75 in which the sixth lens 60 and the seventh lens 70 are cemented by an adhesive. On the image side Lb of the seventh lens 70, a plate-like infrared cut filter 80, a translucent cover 90, and the imaging element 140 are disposed in order from the object side La to the image side Lb. The imaging element 140 is disposed on an imaging plane on the image side Lb of the imaging optical system 100.

The front group 110 includes, in order from the object side La to the image side Lb, a first group 111 having negative power and a second group 112 having positive power. The first group 111 consists of, in order from the object side La to the image side Lb, the first lens 10 and the second lens 20. The first lens 10 is made of glass. The first lens 10 has negative power. The first lens 10 has a convex shape on a lens surface 11 on the object side La and has a concave shape on a lens surface 12 on the image side Lb. The second lens 20 is made of resin. The second lens 20 has negative power. The second lens 20 has a convex shape on a lens surface 21 on the object side La and has a concave shape on a lens surface 22 on the image side Lb. The second lens 20 has an aspherical shape on both surfaces.

The second group 112 consists of, in order from the object side La to the image side Lb, the third lens 30 (second group first lens) and the fourth lens 40 (second group second lens). The third lens 30 is made of resin. The third lens 30 has positive power. The third lens 30 has a concave shape on a lens surface 31 on the object side La and has a convex shape on a lens surface 32 on the image side Lb. The third lens 30 has an aspherical shape on both surfaces. The fourth lens 40 is made of resin. The fourth lens 40 has negative power. The fourth lens 40 has a concave shape on a lens surface 41 on the object side La and has a convex shape on a lens surface 42 on the image side Lb. The fourth lens 40 has an aspherical shape on both surfaces.

The rear group 120 consists of, in order from the object side La to the image side Lb, the fifth lens 50 and the cemented lens 75. The cemented lens 75 consists of, in order from the object side La to the image side Lb, the sixth lens 60 (object-side lens) and the seventh lens 70 (image-side lens). The sixth lens 60 and the seventh lens 70 are cemented by an adhesive.

The fifth lens 50 is made of glass. The fifth lens 50 has positive power. The fifth lens 50 has a convex shape on a lens surface 51 on the object side La and has a convex shape on a lens surface 52 on the image side Lb. The sixth lens 60 is made of resin. The sixth lens 60 has negative power. The sixth lens 60 has a concave shape on a lens surface 61 on the object side La and has a concave shape on a lens surface 62 on the image side Lb. The sixth lens 60 has an aspherical shape on both surfaces. The seventh lens 70 is made of resin. The seventh lens 70 has positive power. The seventh lens 70 has a convex shape on a lens surface 71 on the object side La and has a convex shape on a lens surface 72 on the image side Lb. The seventh lens 70 has an aspherical shape on both surfaces.

### Lens Configuration

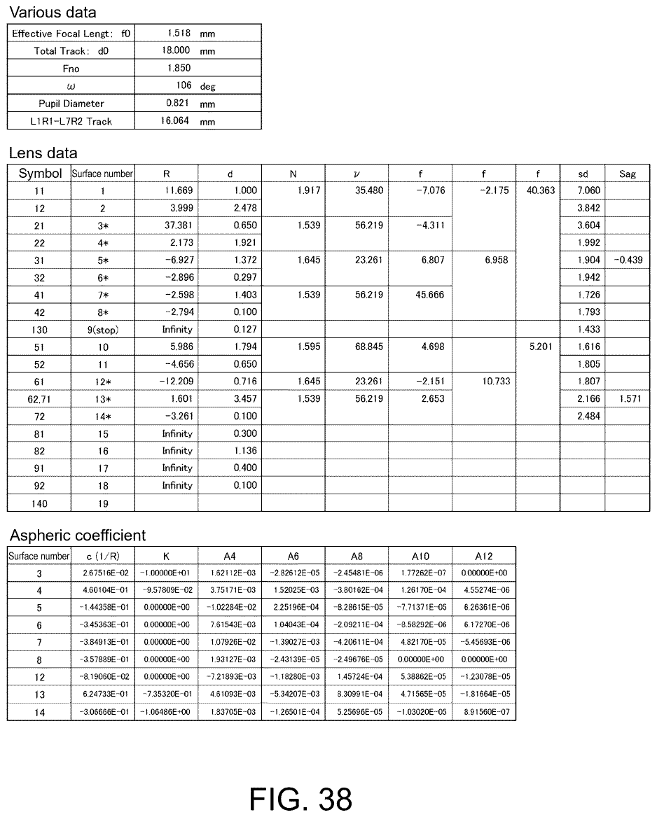

FIG. 38 is a diagram showing data of the imaging optical system 100 of Embodiment 7. The imaging optical system 100 of the present embodiment satisfies the conditional expressions (1) to (15) described in Embodiment 1.

In the present embodiment,

$$v 21 = 23.2 \; 61 \\ v 22 = 56.219 \\ f 3 = 6.8 \; 07 , and \\ f 4 = 45.666 .$$

Therefore, ν21=23.261 and the conditional expressions (1) and (1A) are satisfied. ν22=56.219 and the conditional expressions (2) and (2A) are satisfied. |f3/f4|=0.149 and the conditional expression (3) is satisfied.

In the present embodiment,

$$v 21 = 23.2 \; 61 \\ v 22 = 56.2 \; 19 \\ Sag 71 = 1.5 \; 71 , and \\ sd 71 = 2.166 .$$

Therefore, ν21=23.261 and the conditional expressions (1) and (1A) are satisfied. ν2 =56.219 and the conditional expressions (2) and (2A) are satisfied. |Sag71/sd71|=0.726 and the conditional expression (4) is satisfied.

In the present embodiment,

$$Sag 31 = - 0.4 \; 39 , and \\ sd 31 = 1.904 .$$

Therefore, |Sag31/sd31|=0.231 and the conditional expression (5) is satisfied.

In the present embodiment,

$$f 0 = 1.5 \; 18 , and \\ f 34 = 6.958 .$$

Therefore, f34/f0=4.583 and the conditional expression (6) is satisfied.

In the present embodiment,

$$f 0 = 1.5 \; 18 \\ R 61 = - 12.2 \; 09 , and \\ R 71 = 1.601 .$$

Therefore, R61/f0=−8.042 and the conditional expression (7) is satisfied. R71/f0=1.054 and the conditional expression (8) is satisfied.

In the present embodiment,

$$R 61 = - 12.2 \; 09 , and \\ R 62 = 1.601 .$$

Therefore, (R61+R62)/(R61-R62)=0.768 and the conditional expression (9) is satisfied.

In the present embodiment,

$$f 0 = 1.5 \; 18 , and \\ d 0 = 18.000 .$$

Therefore, d0/f0=11.856 and the conditional expression (10) is satisfied.

In the present embodiment,

$$R 51 = 5.956 , and \\ R 52 = - 4.656 .$$

Therefore, the conditional expression (11) is satisfied.

In the present embodiment,

$$v 6 = 23.2 \; 61 , and \\ v 7 = 56.219 .$$

Therefore, ν6=23.261 and the conditional expression (12) is satisfied. ν7=56.219 and the conditional expression (13) is satisfied.

In the present embodiment,

$$ω = 106 .$$

Therefore, the conditional expression (14) is satisfied.

In the present embodiment,

$$T 1 = 1.0 \; 00 , and \\ f 0 = 1.518 .$$

Therefore, T1/f0=0.659 and the conditional expression (15) is satisfied.

(Operation Effect)

Since the imaging optical system 100 of Embodiment 7 satisfies the conditional expressions (1) to (15) as in Embodiment 1, the same effects as those of Embodiment 1 can be achieved.

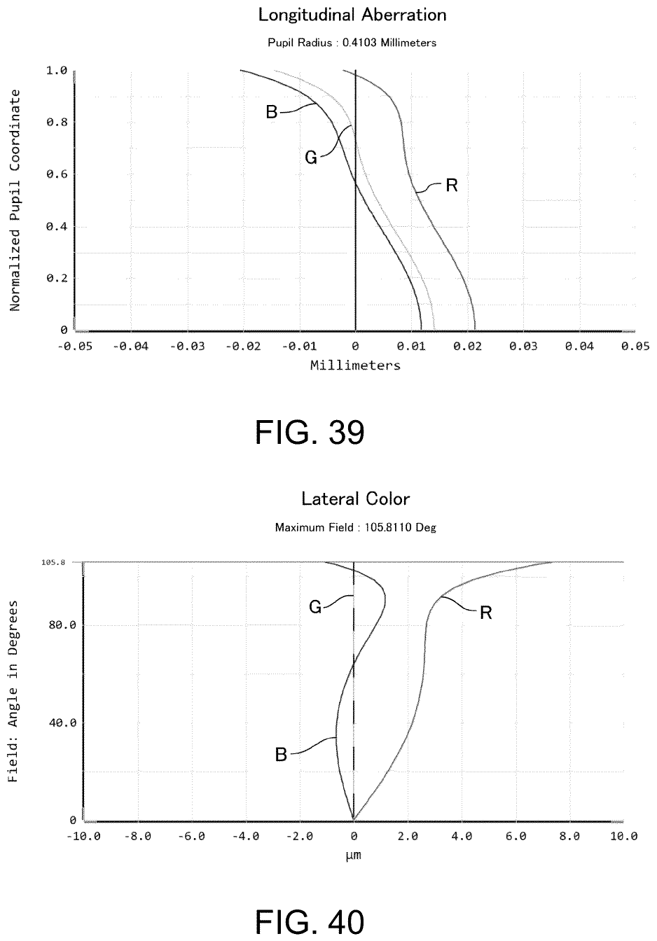

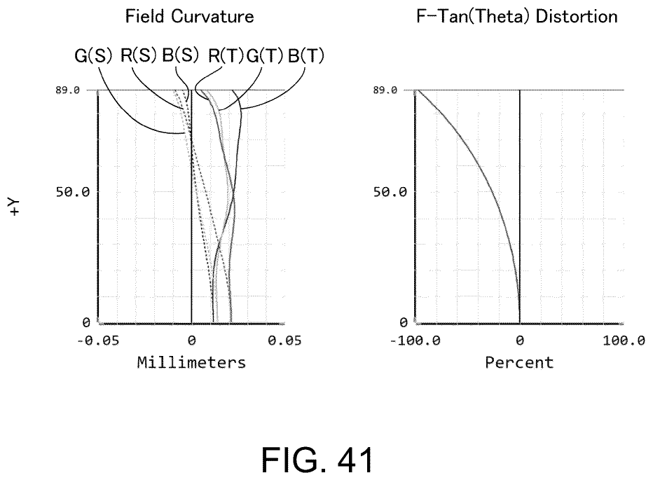

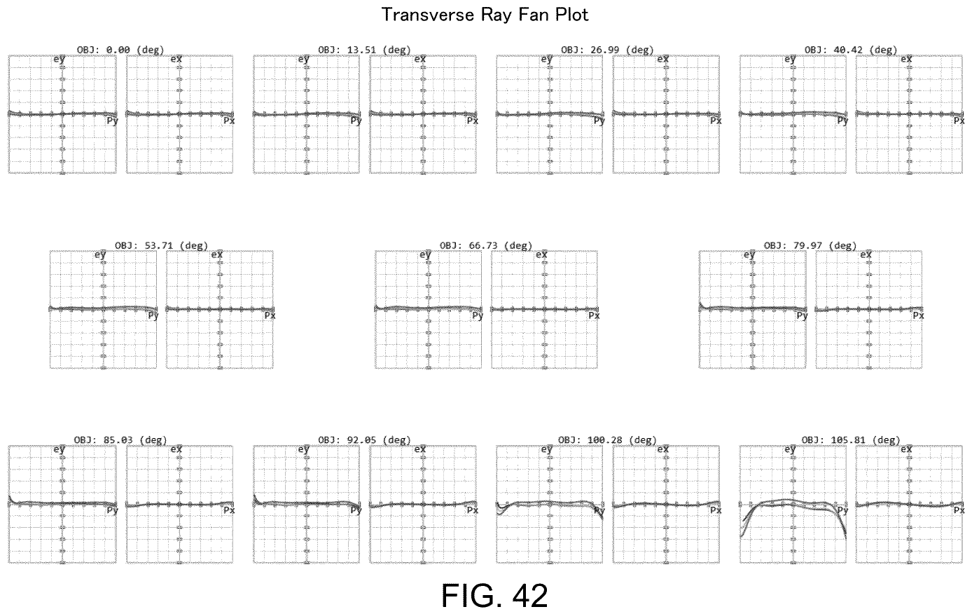

FIG. 39 is a diagram showing the spherical aberration of the imaging optical system 100 shown in FIG. 37. FIG. 40 is a diagram showing the chromatic aberration of magnification of the imaging optical system 100 shown in FIG. 37. FIG. 41 is a diagram showing the astigmatism and the distortion of the imaging optical system 100 shown in FIG. 37. FIG. 42 is a diagram showing the lateral aberration of the imaging optical system 100 shown in FIG. 37.

As shown in FIGS. 39 to 42, in the imaging optical system 100 of the present embodiment, the spherical aberration, the chromatic aberration of magnification, the astigmatism (distortion), the lateral aberration, and the resolution are corrected to appropriate levels.

The present technique can be configured as follows.

### Supplementary Note 1

An imaging optical system comprising: a front group, a diaphragm, and a rear group in order from an object side to an image side, wherein
the front group comprises: a first group having negative power, and a second group having positive power in order from the object side to the image side,
the second group comprises: a second group first lens, and a second group second lens that is adjacent to the second group first lens on the image side and is disposed closest to the image side, and
where ν21 is an Abbe number of the second group first lens, ν22 is an Abbe number of the second group second lens, f3 is a focal length of the second group first lens, and f4 is a focal length of the second group second lens, the following conditional expressions are satisfied:

$$v 21 < 30.$$

$$44. < v 22 , and$$

$$0. < \vert f 3 / f 4 \vert < 0.5 .$$

### Supplementary Note 2

The imaging optical system according to Supplementary Note 1, wherein
where Sag31 is a sag amount of a lens surface on the object side of the second group first lens, and sd31 is an effective radius of a lens surface on the object side of the second group first lens, the following conditional expression is satisfied:

$$0. < \vert Sag 31 / sd 31 \vert < 0.25 .$$

### Supplementary Note 3

The imaging optical system according to Supplementary Note 1 or 2, wherein
where f0 is a focal length of an entire lens system, and f34 is a focal length of the second group, the following conditional expression is satisfied:

$$2. < f 34 / f 0 < 6.000 .$$

### Supplementary Note 4

The imaging optical system according to any one of Supplementary Notes 1 to 3, wherein
where f0 is a focal length of an entire lens system, and R31 is a curvature radius of a lens surface on the object side of the second group first lens, the following conditional expression is satisfied:

$$8. < \vert R 31 / f 0 \vert .$$

### Supplementary Note 5

The imaging optical system according to any one of Supplementary Notes 1 to 4, wherein
the second group first lens has positive power,
a lens surface on the object side of the second group first lens has a convex shape in a vicinity of an optical axis and a concave shape in a periphery, and
a lens surface on the image side of the second group first lens has a convex shape.

### Supplementary Note 6

The imaging optical system according to any one of Supplementary Notes 1 to 5, wherein the second group first lens and the second group second lens are made of resin.

### Supplementary Note 7

The imaging optical system according to any one of Supplementary Notes 1 to 6, wherein
where f0 is a focal length of an entire lens system, and d0 is a total length of the entire lens system, the following conditional expression is satisfied:

$$10. < d 0 / f 0 < 15.000 .$$

### Supplementary Note 8

The imaging optical system according to any one of Supplementary Notes 1 to 7, wherein
the first group consists of a first lens and a second lens in order from the object side to image side,
the second group consists of a third lens that is the second group first lens, and a fourth lens that is the second group second lens in order from the object side to the image side, and
the rear group consists of a fifth lens, a sixth lens, and a seventh lens in order from the object side to the image side.

### Supplementary Note 9

The imaging optical system according to Supplementary Note 8, wherein
the fifth lens is made of glass, and
where R51 is a curvature radius of a lens surface on the object side of the fifth lens, and R52 is a curvature radius of a lens surface on the image side of the fifth lens, the following conditional expression is satisfied:

$$\vert R 52 \vert < \vert R 51 \vert .$$

### Supplementary Note 10

The imaging optical system according to Supplementary Note 8 or 9, wherein
where ν6 is an Abbe number of the sixth lens, and ν7 is an Abbe number of the seventh lens, the following conditional expressions are satisfied:

$$v 6 < 30.0 \; 00 , and$$

$$50. < v 7.$$

### Supplementary Note 11

An imaging apparatus comprising:
the imaging optical system according to any one of Supplementary Notes 1 to 10; and
an imaging element, disposed on the image side of the imaging optical system.

What is claimed is:

1. An imaging optical system comprising:
a front group, a diaphragm, and a rear group in order from an object side to an image side,
wherein
the front group comprises: a first group having negative power, and a second group having positive power in order from the object side to the image side,
the second group comprises: a second group first lens, and a second group second lens that is adjacent to the second group first lens on the image side and is disposed closest to the image side, and
where ν21 is an Abbe number of the second group first lens, ν22 is an Abbe number of the second group second lens, f3 is a focal length of the second group first lens, and f4 is a focal length of the second group second lens, the following conditional expressions are satisfied:
$$v 21 < 30 \text{.000}$$
$$44. < v 22 , and$$
$$0. < \vert f 3 / f 4 \vert < 0. 500 .$$

2. The imaging optical system according to claim 1, wherein
where Sag31 is a sag amount of a lens surface on the object side of the second group first lens, and sd31 is an effective radius of a lens surface on the object side of the second group first lens, the following conditional expression is satisfied:
$$0. < \vert Sag 31 / sd 31 \vert < 0. 250 .$$

3. The imaging optical system according to claim 1, wherein
where f0 is a focal length of an entire lens system, and f34 is a focal length of the second group, the following conditional expression is satisfied:
$$2. < f 34 / f 0 < 6.000 .$$

4. The imaging optical system according to claim 1, wherein
where f0 is a focal length of an entire lens system, and R31 is a curvature radius of a lens surface on the object side of the second group first lens, the following conditional expression is satisfied:
$$8. < \vert R 31 / f 0 \vert .$$

5. The imaging optical system according to claim 1, wherein
the second group first lens has positive power,
a lens surface on the object side of the second group first lens has a convex shape in a vicinity of an optical axis and a concave shape in a periphery, and
a lens surface on the image side of the second group first lens has a convex shape.

6. The imaging optical system according to claim 1, wherein
the second group first lens and the second group second lens are made of resin.

7. The imaging optical system according to claim 1, wherein
where f0 is a focal length of an entire lens system, and d0 is a total length of the entire lens system, the following conditional expression is satisfied:
$$10. < d 0 / f 0 < 15.000 .$$

8. The imaging optical system according to claim 1, wherein
the first group consists of a first lens and a second lens in order from the object side to t image side,
the second group consists of a third lens that is the second group first lens, and a fourth lens that is the second group second lens in order from the object side to the image side, and
the rear group consists of a fifth lens, a sixth lens, and a seventh lens in order from the object side to the image side.

9. The imaging optical system according to claim 8, wherein
the fifth lens is made of glass, and
where R51 is a curvature radius of a lens surface on the object side of the fifth lens, and R52 is a curvature radius of a lens surface on the image side of the fifth lens, the following conditional expression is satisfied:
$$\vert R 52 \vert < \vert R 51 \vert .$$

10. The imaging optical system according to claim 8, wherein
where ν6 is an Abbe number of the sixth lens, and ν7 is an Abbe number of the seventh lens, the following conditional expressions are satisfied:
$$v 6 < 30.0 \; 00 , and$$
$$50. < v 7.$$

11. An imaging apparatus comprising:
the imaging optical system according to claim 1; and
an imaging element, disposed on the image side of the imaging optical system.

12. The imaging optical system according to claim 2, wherein
where f0 is a focal length of an entire lens system, and f34 is a focal length of the second group, the following conditional expression is satisfied:
$$2. < f 34 / f 0 < 6.000 .$$

13. The imaging optical system according to claim 9, wherein
where ν6 is an Abbe number of the sixth lens, and ν7 is an Abbe number of the seventh lens, the following conditional expressions are satisfied:
$$v 6 < 30.0 \; 00 , and$$
$$50. < v 7.$$
